(19) United States
(12) Patent Application Publication
(10) Pub. No.: US 2005/0278160 A1
(43) Pub. Date: Dec. 15, 2005

(54) Reduction of settling time in dynamic simulations

(76) Inventors: James Michael Donnelly, West Linn, OR (US); Weston R. Beal, Wilsonville, OR (US); Subbarao V. Somanchi, Beaverton, OR (US)

Correspondence Address: KLARQUIST SPARKMAN, LLP, 121 SW SALMON STREET, SUITE 1600, PORTLAND, OR, 97204, US

(21) Appl. No.: 10/868,664

(22) Filed: Jun. 14, 2004

(51) Int. Cl. G06F 17/50

(52) U.S. Cl. 703/19; 703/14

(57) ABSTRACT

Settling time in dynamic simulations of circuits is significantly reduced by changing the value of one or more simulated energy storage elements corresponding to energy storage elements in a circuit being simulated. The value of the simulated energy storage element, such as the capacitance in the case where the energy storage element is a capacitor, is changed from at least one fast settling value to a simulated design value that corresponds to the design value of the actual energy storage element in the circuit being simulated.

### TECHNICAL FIELD

The technology of this disclosure relates to reducing settling time in dynamic simulations of electrical and other circuits to equilibrium conditions or steady-state operating points of interest in a simulation.

### BACKGROUND

For many circuits that are to be simulated, the dynamic equilibrium or operating point cannot effectively be evaluated from static analysis. Dynamic simulation is desirable. However, often the settling time constants of the circuits are very long. In contrast, the post-equilibrium simulation time of interest for transient performances of a circuit following equilibrium are often quite short. The long settling time is typically a function of relatively large energy storing components in the circuits, such as large DC blocking capacitors. Circuits with such components require a long simulation run to allow the circuit simulation to settle or reach equilibrium while only a few simulation cycles following equilibrium are of interest. Therefore, simulation time is extended while waiting for settling of the simulation to take place.

### SUMMARY

The description proceeds with reference a number of illustrative embodiments. These embodiments do not limit the breadth of the invention disclosed herein and are simply examples to help in the understanding of the invention. The invention is directed to all novel and non-obvious features and method acts disclosed herein both alone and in various combinations and subcombinations with one another as set forth in the claims below. The invention is not limited to a specific combination of one or more features or method acts.

For purposes of this disclosure, the word “including” has the same broad meaning as the word “comprising”. In addition, words such as “a” and “an”, unless otherwise indicated to the contrary, include the plural as well as the singular. Thus, for example, the requirement of “a feature” is satisfied where one or more of these features are present. In addition, the term “or” includes the conjunctive, the disjunctive and both (A or B thus includes either A or B, as well as A and B).

Assume a circuit has at least one energy storage element having a design value. In accordance with an embodiment, at least one simulation value is assigned to an energy storage element that is less than the simulation design value that corresponds to the design value of the energy storage element in the actual circuit. These energy storage elements each have at least one associated state variable corresponding to a through or across variable of the simulated energy storage element (e.g., corresponding to the simulated voltage across a capacitor, the simulated current through an inductor, and the simulated angular velocity of a rotating object). The energy storage of these energy storage elements is represented by a known formula which is expressed for many energy storage elements as:
E=½(c)[v(t)]²
wherein E is the energy, c is an energy storage coefficient (e.g., capacitance value, inductance value, inertia value) and [v(t)] is the state variable as a function of time (e.g., the changing simulated voltage across a simulated capacitor, changing simulated current through a simulated inductor, and changing angular velocity through a simulated rotating object). These simulation design values are typically coefficients indicative of the energy storage capacity of the energy storage elements (e.g., the simulated capacitance value of a simulated capacitor or the simulated inductance value of a simulated inductor). The assigned at least one simulation value may be deemed a fast settling value which is less than the simulation design value for the storage element. When a simulation of the circuit is performed with the simulated storage element at a fast settling value, settling of the simulation is accelerated. That is, settling of a state variable associated with the energy storage element to an equilibrium or steady-state condition is accelerated. Following a first simulation and after a first simulation time interval, the value of the simulated storage element is changed from a fast simulation value to the simulation design value. A second simulation is performed for a second simulation time interval with the simulated storage element at the simulated storage element design value. The results of the first simulation are desirably used as starting conditions for the second simulation. That is, the second simulation is desirably started with the state variable at the value it reached at the end of the first simulation.

As a specific example, in high speed chip-to-chip signal transmission applications (e.g., at one gigahertz or more), a data signal passes from one chip to another with a DC blocking capacitor placed in the signal path. The DC blocking capacitor typically has a very high capacitance value so that it does not interfere with the high speed operation of the circuit other than blocking direct current signals. When initially stimulated by a signal which switches values, such as a periodic clocking signal, the voltage across a DC blocking capacitor takes some time to settle to its equilibrium or steady-state-condition after which the DC blocking capacitor is transparent to the circuit operation. It is desirable in a simulation to accelerate this settling of state variables across or through terminals or pins so that the circuit performance of interest following equilibrium can be evaluated.

The input signals to the circuit may switch values, meaning that the inputs change between high and low values. These input signals may be otherwise referred to as drive or stimulus signals for the circuit. These switching signals may be regular periodic signals such as clock input signals and may have logic one and logic zero values, but this is not required. Alternatively, these switching signals can be irregular or quasi-periodic rather than periodic. The term “switching signals” does not mean that switches are actually used in generating the data signals but only that the values of the signals inputs shift or switch.

The embodiments are not limited to fast settling simulations of electrical circuit energy storage components such as capacitors or inductors. Fluidic, thermal and mechanical energy storage elements are other examples of circuit components which can be simulated using the techniques disclosed herein. Fast settling simulations of mixed forms of energy storage components (e.g., multiple types of such elements in the same circuit that is being simulated) may also be performed. Simulation models run in a simulator may be used to perform these simulations.

In certain embodiments, a first simulation is performed using at least one fast settling value for an energy storage element for a first simulation time interval and a second simulation is performed for at least a second simulation time interval with the simulated storage element at the simulated design value. It is not necessary that there is a one-to-one correspondence between first and second simulations. For example, the results of a first simulation may be stored and used as a starting condition for one or more second simulations. Also, the second simulation time interval may immediately follow the first simulation time interval or a delay may be interposed between the first and second simulations.

In accordance with an embodiment, a training sequence may be used as a data or stimulus input for a simulated circuit for at least a portion of the first simulation and more desirably for the entire first simulation. The training sequence is desirably periodic in the case of a clocked circuit and may comprise a repetitive pattern of logic level one and logic level zero data bits. In one specific example, the bits may alternate between logic level one and logic level zero values. Also, the training data sequence may be continued for a time interval following settling of the state variable of an equilibrium or steady-state condition prior to changing of the value of the simulated storage element from a fast settling value to a simulated design value. As a specific example, this latter time interval may be at least one-half of the period of a periodic training sequence. Thereafter, actual simulation data may be delivered. Desirably, the training sequence and the actual data have the same DC bias.

The duration of the first simulation time interval may be predetermined by a user in one embodiment. Desirably, the first simulation time interval is at least equal to the simulation time interval required for the state variable of the simulated storage element to settle to an equilibrium or steady-state condition. The phrase “settled to an equilibrium or steady-state condition” encompasses substantial settling such as a case wherein the state variable has substantially stabilized about an operating point. As another example, the maximum or minimum values, or both, of state variables from the simulated storage element may be compared. The state variables may be deemed to be in a settled condition if the corresponding maximums from one cycle and a succeeding cycle (the next or a subsequent cycle), the corresponding minimums from one cycle and a succeeding cycle, or the corresponding maximums and minimums from one cycle and a succeeding cycle, are within a threshold. This threshold may be varied and may be user designated in some embodiments.

The value of the simulated storage element in one embodiment may be changed from a fast settling value to a simulated storage element design value automatically following the output reaching an equilibrium output condition. Alternatively, the changeover may be accomplished in response to user direction following settling to an equilibrium condition. For example, the user may designate a changeover time or a first simulation time interval.

Desirably in accordance with certain embodiments, a signal may be produced to indicate the settling of the simulated storage component output to an equilibrium output condition.

Changing from one fast settling value to a simulated design value of the energy storage element may be accomplished at a simulation time at which the state variable of the simulated storage element has reached an equilibrium or steady-state condition and at which the state variable is at a value that is between high and low values. For example, shifting may be accomplished when the state variable is at an average of the high and low state variable values (which includes being substantially at the average value).

Plural first or fast settling values may be used in performing a first simulation. Alternatively, a single fast settling value may be used for the first simulation. The user may designate one or more of the fast settling values. Alternatively, the fast settling value or values may automatically be determined. For example, the state variable of an energy storage element may have a ripple in response to stimulus. The ripple may be evaluated for use in adjusting the fast settling value. The fast settling value may, for example, be adjusted to limit the maximum swings of the ripple between high and low threshold values. In one specific approach, a fast settling value is increased in the event the ripple exceeds a first higher threshold and decreased in the event the ripple is below a second lower threshold. An iterative process may be used to select a fast settling value under this approach. An existing fast settling value may be adjusted to a new fast settling value by multiplying the existing fast settling value by a first factor in the event the ripple exceeds the first higher threshold and by dividing the existing fast settling value by a second factor in the event the ripple is less than a third factor (e.g., a fraction) of the first higher threshold.

As another exemplary embodiment, the circuit components being simulated may comprise at least one pair of differential capacitors. The simulation may be performed using first and second simulated capacitors. In one embodiment, the state variable of only one of the simulated capacitors is monitored to determine the existence of the equilibrium or steady-state condition. The values of both of the simulated capacitors may be adjusted from fast settling values to their respective design values upon settling to an equilibrium or steady-state condition.

A computer may be programmed to carry out one or more of the novel and non-obvious method acts disclosed herein and is within the scope of the present invention. In addition, computer readable media programmed with instructions to carry out one or more of the novel and non-obvious method acts disclosed herein is also within the scope of the invention.

The simulated minimum and maximum voltage or other state variable deviations about a dynamic operating point in some embodiments is monitored. The value of a simulated energy storage element may be changed to the simulated design value at the next time the state variable is at the average value. This approach enhances the accuracy of equilibrium or steady-state point prediction in the presence of periodic voltage or input signal deviations. Also, in certain embodiments, by tracking the settling voltage or other state variable envelope, the appropriate simulation time for changing the value of the energy storage element to the simulated design value may be automatically determined.

A settled indicating signal may be generated and displayed to indicate that an equilibrium or steady-state condition of a state variable has occurred. Alternatively, the settled indicating signal may be used to indicate to a simulator when to commence the sending of actual simulation data following a training signal. The settled indicating signal may also be used to indicate the start of post-equilibrium or post-steady-state simulations which then can be stopped, for example, a few cycles following the determination of the settled condition.

In addition, in accordance with a number of embodiments, various simulation models are disclosed for accomplishing simulations using energy storage elements or components having coefficient values which are shifted by the model between one or more fast settling or initial values and simulation design values.

The circuits that are being simulated may have one or more energy storage elements to which the fast settling technology is applied. In addition, these energy storage elements may be components or portions of other circuit components and nevertheless may be simulated using these approaches.

### BRIEF DESCRIPTION OF THE DRAWINGS

FIG. 1 illustrates an example of an electrical circuit schematic diagram of one form of a high-speed digital interconnect having an AC coupling (DC blocking) capacitor.

FIG. 2 illustrates an example of a simulation circuit with simulation components that may be used to simulate the circuit of FIG. 1.

FIG. 3 illustrates the substantial simulation time required for a specific example of the circuit of FIG. 2 to settle without changing the capacitance of the simulated coupling capacitor from at least one fast settling value to a simulated design value.

FIG. 4 illustrates the substantial reduction in simulation time required for settling in the event the capacitance of the simulated coupling capacitor value is shifted from a fast settling value to a simulated design value.

FIG. 5 is a time scale expanded view of a portion of FIG. 4.

FIG. 6 is a graph illustrating the ripple voltage across a simulated capacitor in one form of a fast settling capacitor simulation model as settling takes place and following the change in capacitance value from a fast settling value to the simulated design value.

FIG. 7 illustrates changing a simulated capacitance value in the model from a fast settling value to a simulated design value.

FIG. 8 illustrates an enlarged view of voltage across the simulated capacitor of a fast settling capacitor simulation model immediately before and after shifting the capacitance to a simulated design value.

FIG. 9 illustrates current values corresponding to the voltage values of FIG. 8.

FIG. 10 illustrates an alternative simulation circuit to that shown in FIG. 2 wherein the capacitor simulation model is an adaptive model and has an output indicating settling of the simulated capacitor state variable to an equilibrium condition and that the capacitance has been changed to the simulated design value.

FIG. 11 is identical to FIG. 2 and is repeated to provide a comparison to FIG. 12.

FIG. 12 illustrates settling of the simulated capacitor output to the equilibrium condition utilizing a form of adaptive model of FIG. 10 for the simulation.

FIG. 13A is a time scale expanded illustration of a portion of the illustration of FIG. 12.

FIG. 13B illustrates an example of the timing for the automatic (or adaptive) shifting of the simulated capacitance value from a fast settling value to a simulated design value.

FIG. 14 illustrates the voltage across the simulated capacitor of the model of FIG. 10.

FIG. 15 illustrates the adjustment of the capacitance of the simulated capacitor of the model of FIG. 10 to several fast settling values followed by an adjustment to the simulated capacitance design value.

FIG. 16 is a circuit schematic diagram for first and second AC coupling capacitors used in a differential circuit.

FIG. 17 is an exemplary simulation model for the circuit of FIG. 16, including fast settling models that simulate the differential capacitor pair of FIG. 16.

FIG. 18 is another example of a simulation model for the circuit of FIG. 16 with an alternative adaptive form of fast settling model for the differential capacitor pair of FIG. 16.

FIG. 19 illustrates the settling of the state variable of a simulation capacitor of the simulation model of FIG. 17 to an equilibrium or steady-state condition.

FIG. 20 illustrates the settling of the state variable of a simulated capacitor of the simulation model of FIG. 18 to an equilibrium or steady-state condition.

FIG. 21 illustrates the state variable of a simulated capacitor in the models of FIGS. 17 and 18 with the dashed line graph in FIG. 21 corresponding to the state variable using the capacitor simulation model of FIG. 17 and the solid line graph in FIG. 21 corresponding to the state variable using the capacitor simulation model of FIG. 18.

FIG. 22 illustrates the changing of capacitance values of simulated capacitors from fast settling values to simulated design values with the dashed line corresponding to the changing of values using the model of FIG. 17 and the solid line corresponding to the changing of values using the model of FIG. 18.

FIG. 23 illustrates a simulation model for a circuit having an energy storage component in the form of an inductor and in which a form of fast settling inductor model is used.

FIG. 24 illustrates the settling of inductor through current, the inductor state variable, in a simulation in which the value of the inductance in the model is shifted from a fast settling value to a simulated design value.

FIG. 25 illustrates the slower settling of inductor through current in a simulation in which the value of the inductance remains at the simulated inductance design value throughout the simulation.

FIG. 26 is an enlarged view (y-axis only) of a portion of the simulated inductor current depicted in FIG. 24.

FIG. 27 is an enlarged view (y-axis only) of a portion of the simulated inductor current depicted in FIG. 25.

FIG. 28 is an enlarged view (x-axis only) of the simulated inductor current of FIG. 24 (shown in the upper solid line graph in FIG. 28) and of the simulated inductor current of FIG. 25 (shown in the lower dashed line graph of FIG. 28).

FIG. 29A illustrates the ripple in the current of a portion of the upper graph in FIG. 28 just prior to and following the shifting of the simulated inductance from a fast settling value to a simulated inductance design value. FIG. 29A illustrates that the change to the simulated inductance design value occurs when the simulated current reaches an average value between maximum and minimum values.

FIG. 29B illustrates voltage signals corresponding to respective simulated maximum and minimum ripple current values of FIG. 29A

FIG. 30 is an example of a simulation using fast settling techniques in the mechanical domain with the energy storage element in FIG. 30 being a flywheel with rotational inertia and a fan.

FIG. 31A illustrates a graph of the fan/motor shaft speed for a simulation in which the simulated design value of inertia is used throughout the entire simulation.

FIG. 31B illustrates the more rapid settling of the fan/motor shaft speed to an equilibrium or steady-state condition in a simulation in which a model uses a fast settling inertia value that is shifted to the simulated design value of the inertia.

FIG. 32 is an enlarged view (y-axis only) of the graphs of FIGS. 31A and 31B with the left-hand portion of the graph of FIG. 32 corresponding to a portion of FIG. 31B and the right-hand graph of FIG. 32 corresponding to a portion of FIG. 31A.

FIG. 33 is an enlarged view (x-axis only) of portions of the graphs of FIGS. 31A and 31B with data from a portion of the graph of FIG. 31B depicted in the upper graph of FIG. 33 and data from a portion of the graph of FIG. 31A depicted in the lower graph of FIG. 33.

FIG. 34 illustrates the angular velocity state variable just before and just following the simulation shifting from a fast value of simulated inertia to the design value of simulated inertia; FIG. 34 illustrates that the switching to the simulated design value of inertia is accomplished when the angular velocity is an average of the minimum and maximum angular velocities.

FIG. 35 illustrates an example simulation using torque zero crossings in FIG. 35 to identify the respective minimum and maximum angular velocities in FIG. 34.

FIG. 36 illustrates a simulation model involving a fan and flywheel that is driven by an induction motor.

FIG. 37 is a graph illustrating the settling of the angular velocity in the FIG. 36 simulation wherein a fast settling initial inertia is shifted to the simulated design value of inertia.

FIG. 38 is a graph showing settling of the angular velocity in the simulation of FIG. 36, but wherein the design value of inertia is used in the simulation model throughout.

FIG. 39 illustrates an expanded view (y-axis only) of the respective graphs of FIGS. 37 and 38 with a portion of the data from the graph of FIG. 37 being depicted in the left-hand graph of FIG. 39 and a portion of the data from the graph of FIG. 38 being depicted in the right-hand graph of FIG. 39.

FIG. 40 illustrates an individual phase current of an induction motor in the simulation of FIG. 36 and shows the time required for settling of the state variable to an equilibrium or steady-state condition without the use of a fast settling simulation inertia value.

FIG. 41 illustrates the more rapid settling of an individual phase current of an induction motor in the simulation of FIG. 36 when the simulation shifts the inertia from a fast settling value to the simulated inertia design value.

FIG. 42A illustrates the current (solid line) and voltage (dashed line) for a simulation of a motor after nearly nine seconds of simulation time and wherein the simulation did not use a fast settling simulated inertia value.

FIG. 42B illustrates the phase current (solid line) and voltage (dashed line) for a motor illustrating two seconds of simulation time in a simulation wherein switching from a fast simulated value of the initial inertia is made to the simulated design value of inertia after 1.2 seconds.

FIG. 43 illustrates the use of an automatic differential fast settling capacitor model in a multi-gigabit serial data transmission application.

FIG. 44A illustrates the simulated voltage across one leg of a simulated capacitor of FIG. 43 and shows the ripple voltage state variable and rapid settling to an equilibrium or steady state.

FIG. 44B is a graph of an example of a settled indicating output signal.

FIG. 44C illustrates the shifting of capacitance values by the simulation model from a fast settling values to a simulated capacitance design value (the simulated capacitance design value being off the scale and not shown in this figure).

FIG. 45A illustrates the simulated differential voltage output at the receiver of the simulation of FIG. 43.

FIG. 45B illustrates a settled indicating output signal.

FIG. 45C is a graph of data being delivered to a driver in the simulation of FIG. 43.

FIG. 46 is an Eye-Diagram overlaying 250 databits that were received in the final 100 nanoseconds of the simulation of FIG. 45A.

FIG. 47 is a graph of the output of the differential receiver of FIG. 43 for 500 nanoseconds of simulation time in a simulation which does not utilize a fast simulation capacitor model to illustrates the lack of settling that has taken place over this simulation time.

FIG. 48 is an Eye-Diagram of the last 100 nanoseconds of the unsettled data of FIG. 47 and illustrates the lack of centering of the Eye on a specification mask.

FIG. 49 illustrates a distributed computer network embodiment which may be used to perform simulations in accordance with the technology disclosed herein.

FIG. 50 illustrates an embodiment of a client server environment in which simulations in accordance with the technology described above may be performed.

### DETAILED DESCRIPTION OF EMBODIMENTS

It is desirable to reduce the longest time constant in simulation models of a periodic or switching circuit in a way that does not disturb the steady-state or equilibrium condition or operating point of the circuit after it settles from starting conditions. In this description, the term steady-state is used interchangeably with the word equilibrium. It is desirable to reach the equilibrium point more quickly during simulation to enable more rapid analysis of faster dynamic behaviors of the circuit that are valid only under equilibrium operating conditions. At steady-state, the state variables of modeled components fluctuate, if at all, about an operating point. This results in a saving of simulation time and can significantly reduce the overall design cycle time of the circuit.

Fast settling simulation models are designed to reduce the simulation time needed for state variables to reach steady-state. In this description, circuits are not limited to electrical circuits. Circuits encompass not only electrical circuits, but also mechanical, thermal, fluidic and mixed circuits and systems incorporating such circuits and other forms of circuits having energy storage elements that require time for one or more state variables to reach an equilibrium condition or steady-state when stimulated.

A circuit or system designer often selects values or coefficients for energy storage components in a circuit at a level which is specifically intended to not interfere or respond to faster signaling or switching frequencies present in the design during normal operation of the circuit. Series AC coupling capacitors in high speed digital networks are a specific example. Such AC coupling capacitors are intended to block DC offsets only, and to not interfere with the high-speed data signals (e.g., drive or stimulus signals) being transmitted. These AC coupling capacitors are often sized many orders of magnitude greater than is necessary to make them transparent to the data-rate switching frequency. This may be simply to provide a design margin, or to accommodate worst-case data-patterns that may occur during operation of the circuit (e.g., long sequences of logic 1 or logic 0 values being transmitted on the net). The fast settling technology disclosed herein allows the simulation user to exploit this design margin by temporarily reducing the margin under controlled conditions, desirably until the steady-state operating point or equilibrium condition is reached. The value of the energy storage component (e.g., the capacitance in the case of a simulated capacitor) in the simulation may then be restored to the simulated design value so that normal operation of the circuit at the design value can be simulated and verified.

In one specific approach, time-constant control (e.g., mechanisms for adjusting values of energy storage elements) are desirably included within the simulation models of fundamental energy storage elements in each simulated technology (e.g., electrical, mechanical, thermal, fluidic, mixed, etc.) to provide fast-settling capability for a wide range of simulation application situations. These energy storage element values correspond to coefficients indicative of the energy storage capability or capacity of the energy storage elements, with specific exemplary coefficient values being the capacitance of a simulated capacitor, the inductance of a simulated inductor, the inertia of a rotating component, and in general to an energy storage coefficient. Exemplary state variables for such energy storage components are through or across state variables (e.g., through terminal or across terminal variables) with specific state variable examples corresponding to across voltage in a simulated capacitor, through current in a simulated inductor, and angular velocity in a simulated rotational element. This fast settling capability may be incorporated into simulation models of energy storage components of circuits of this type wherein the storage elements delay settling of the circuit to an equilibrium condition and wherein the energy storage elements have minimal or no effect on the equilibrium operation of the circuit. Specific algorithms may be built into a simulation engine to force fast settling in accordance with this technology. However, this is less desirable than using general models as specific algorithms for simulation engines may be limited to specific circuit or system topologies. Any suitable model language may be used in specifying models incorporating the technology, such as modem hardware description languages, with IEEE 1076.1 (VHDL-AMS) being one specific example. These hardware description languages provide the state switching, control and analog behavior which is desirable to model the fast settling functionality within the models.

Included among the applications for using the fast settling technology disclosed herein are applications wherein the circuit is being stimulated by a data or switching signal such as a drive or stimulus signal of a periodic nature and of a fixed frequency. Examples of such applications include high speed circuits and power converters where the high speed data rate or the power converter switching frequency is part of the design definition for the circuit. In applications where fixed frequency periodic stimuli are being used, it can be easier to select initial values and switching times because the periodic energy cycle time is known. This facilitates control of the ripple amplitude of the simulated energy storage component state variable as it can be more readily estimated and limited by defining, for example, a minimum initial value for the energy storage coefficient (e.g., the initial capacitance or inductance).

Another exemplary application is where the period of switching signals is governed by the circuit or system “natural” dynamic characteristics, which may not be well-known to the simulation user at the beginning of a simulation. The period may even change as the operating or equilibrium point changes during the simulation, yet the technology remains applicable. As a specific example, in a current controlled DC motor drive, the back-EMF voltage due to the motor speed (Vemf) affects the total voltage across the motor's internal inductance, effectively changing the current switching frequency. That is, the ramp rate of the current (e.g., di/dt=(Vbatt−Vemf)/L) changes as Vemf changes with motor speed. This affects the time required for current to transition between the lower and upper switching thresholds. An induction motor example is another case where the period is governed by dynamic characteristics. In an induction motor example, the torque ripple depends on slip frequency, which itself changes with motor shaft speed. In such “quasi-periodic” switching situations, it can be difficult to choose an initial fast settling value for use in simulating the energy storage component. However, one can start with the nominal value (the design value of the simulated component corresponding to the design value in the circuit) and then progressively reduce the initial value of the simulated storage element by progressive orders of magnitude. The settling can be observed. So long as the system settles to the same equilibrium state operating condition or point, the initial value is usable. This process may be repeated to select an initial fast settling value for the simulation. With this approach, several preliminary simulations may be run for the purpose of finding satisfactory “fast settling” initial simulation values for energy storage elements and to find a suitable time for switching from an initial fast settling value or values to the design value for simulating the normal operation of the circuit. This is useful if multiple simulations are to be made, such as sweeping a design parameter over a range of values. Alternatively, the order can be reversed. For example, one can start with a small value for the energy storage element and increase it to see if the operating point (steady-state) is affected. If not, the previous value may be selected as a suitable initial fast settling value.

The fast settling technology may be more fully understood with reference to some specific examples.

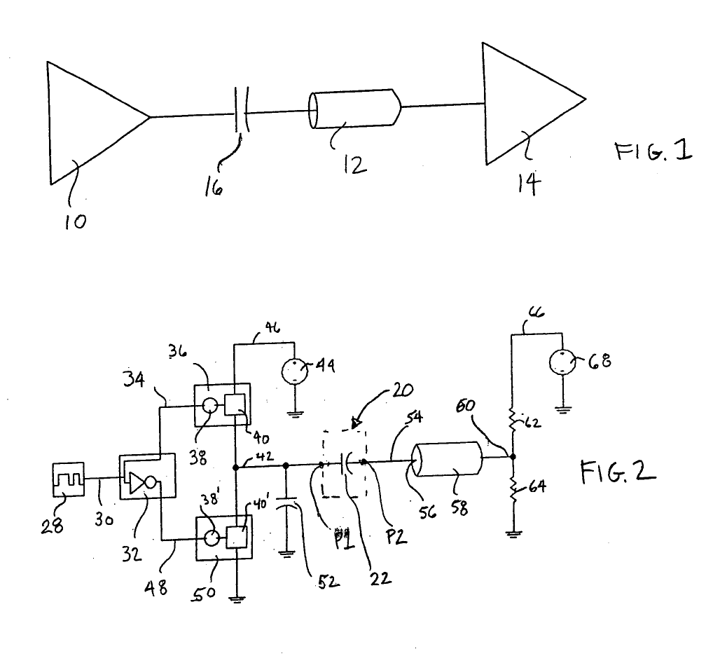

FIG. 1 illustrates a simplified circuit diagram for a high-speed digital interconnect. The circuit of FIG. 1 comprises an output buffer 10 for delivering an output along a transmission line 12 to an input buffer 14. An AC coupling capacitor 16 is interposed between the output and input buffers. As a specific example, assume that the circuit of FIG. 1 is designed to operate at a 400 picosecond clock period and that the design value of capacitor 16 is 10 nanofarads. The fast settling technology becomes more advantageous in examples where typically higher capacitance design values are used, such as 75 nanofarads to 500 nanofarads.

FIG. 2 illustrates an exemplary simulation circuit for modeling the behavior of the circuit of FIG. 1. In FIG. 2, the simulation model for capacitor 16 is indicated at 20 and is shown with pins P1 and P2. The simulated capacitor is indicated at 22 in FIG. 2. The simulation model 20 is an example of a manual fast settling storage element model, in this case a fast settling capacitor model. The other components modeled in the FIG. 2 circuit simulation may be conventional. For example, these model components comprise a data input 28 (e.g., std_logic_vector sdata=(‘0’, ‘1’); time_vector tdata=(400 ps, 400 ps); std_logic s0=‘1’; time t0=10 ps). Simulation signals from data input 28 are delivered by a simulated data input line 30 (d_input) to a controller model 32 (ibis_control). The input to model 32 is delivered via a non-inverted model input line 34 (d_in_ninv) to a non-linear pull-up driver stage model 36 applying a function at model component 38 (k(t)) and a current versus voltage model 40 (ivs.v) to provide a simulated output drive signal on line 42 (v_drv). This model may represent, for example, a pull-up PMOS transistor or other semiconductor element behavior. A DC voltage source model 44, in this example, having a voltage level of 2.0 volts, provides a model output on a line 46 (vcc_drv) to model component 40. The inverted output of model 32 is delivered along a model output line 48 (d_in_inv) to a non-linear pull-down driver stage model 50 having components 38′ and 40′ corresponding to the components 38 and 40. Line 42 is connected to capacitor 52 (Cparallel), which models a small amount of driver output stage capacitance, in this case having capacitance value of cap=1.0e-12. Pin P2 of AC coupling capacitor model 20 is connected via a model line 54 (v_drv_cc) to an input 56 of a lossless transmission line model 58, which in this example, is assigned an impedance value of realz0=70.0 ohms. The output 60 of transmission line model 58 (v_load) is delivered at the intersection between load resisters 62,64 (r5, r6). Load resister 64 is grounded. Load resister 62 is connected through a model line 66 (vcc_rx) to a DC voltage source model 68 which may be set, in this example, at 1.0 volts. The presence of non-linear pull-up and pull-down driver stages 36,50 makes it very difficult to analytically predict a dynamic steady-state voltage across the capacitor 20 between pins P1 and P2 and therefore the average across voltage.

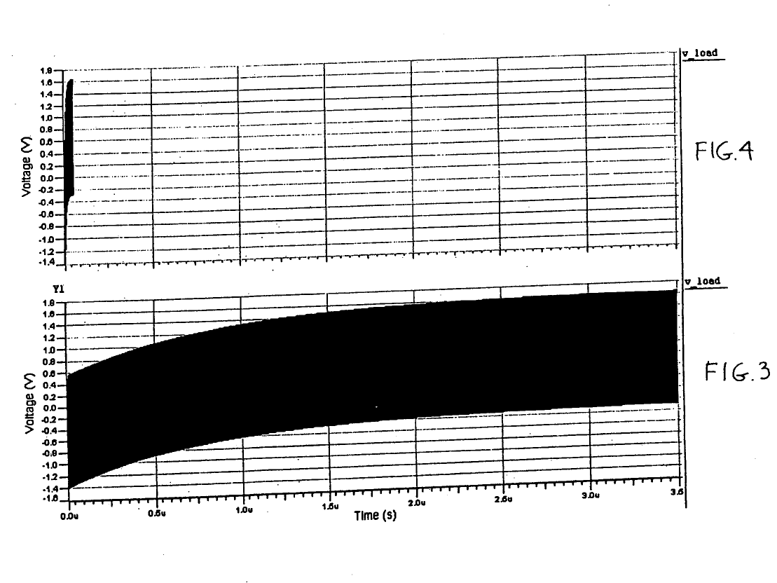

With reference to FIG. 3, which shows the voltage at the load 60, if capacitor model 20 were simply replaced by a model of a capacitor having a simulation value corresponding to the design value of capacitor 16 (10 nanofarads) with a 2.5 Gigabits per second input signal (400 picosecond clock period), it would take over 3.5 microseconds of simulation time for the state variable (across voltage) of the capacitor model to settle to its steady-state value. This is a significant amount of simulation time in comparison to what is typically only a very few simulation cycles of interest of data responses to the data applied after the simulated capacitor has settled.

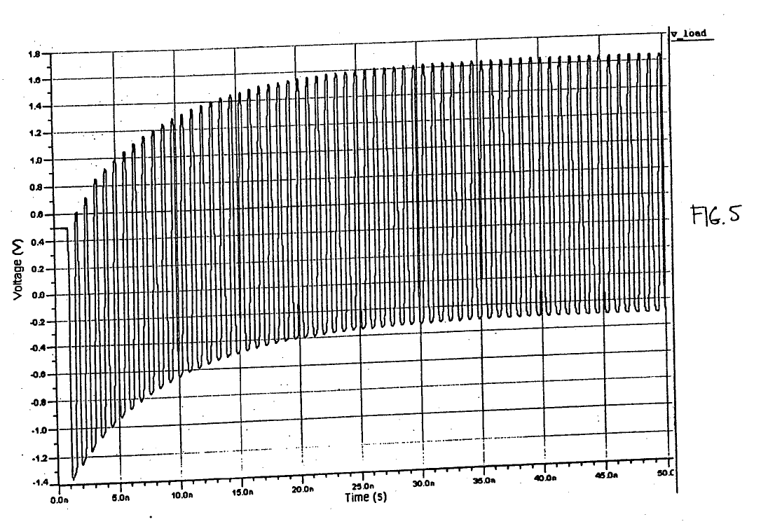

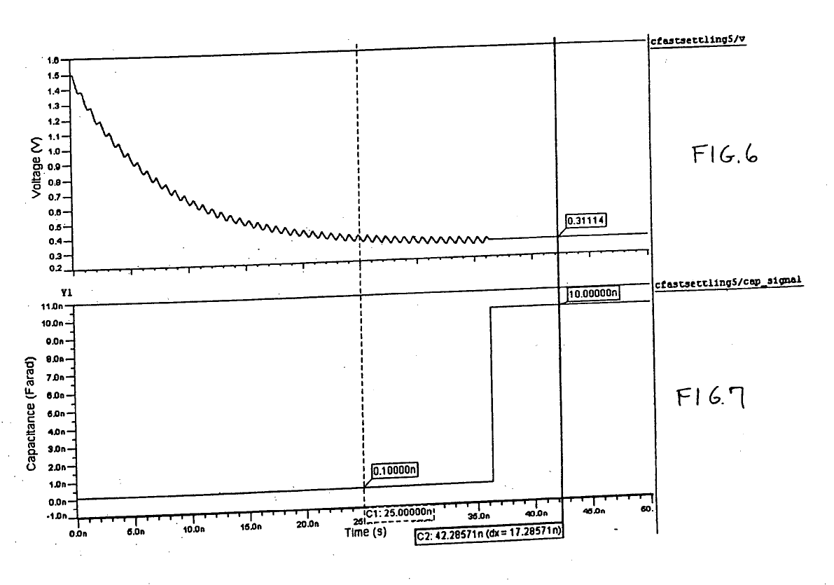

By reducing the value of the capacitance of simulated capacitor component 22 of model 20 to one or more fast settling values, settling of the simulation to the equilibrium state occurs more rapidly. Following settling, the value may then be changed to the simulated design value with the data of interest being applied and the results of interest then being captured following settling. With a fast settling capacitor model 20, in this case a manual fast settling model, as indicated in FIG. 4 it takes only about 35 nanoseconds of simulation time for settling to occur. This is more clearly represented in FIG. 5 where after about 35 nanoseconds the voltage load is at its equilibrium condition (e.g., the steady-state value of simulated capacitor state variable voltage does not significantly change and thus the load voltage is stable).

Desirably, in the fast simulation a training signal is applied prior to the time the equilibrium condition is reached. The training signal is desirably a repetitive pattern and a training sequence of alternating logic values ‘1’, ‘0’, ‘1’, ‘0’, etc. may be transmitted. The actual simulated digital data signal (the stimulus or drive signal) replaces the training sequence desirably after settling of the state variable has occurred and the capacitance value of capacitor 22 in the model 20 has been switched from a fast settling value to the higher simulated design capacitance value that simulates the capacitance of capacitor 16 (FIG. 1).

A specific example of the fast simulation model 20 used in the simulation of FIG. 2 is described below and can be used, for example, in series (e.g., AC coupling) capacitor applications. In the simulation using the model 20, the circuit settles to the dynamic steady-state or equilibrium condition quickly. The capacitance transitions from an initial fast settling value “cap_initial” to a simulated design value (“cap_final”) corresponding to the design value of the capacitance of the actual circuit capacitor 16 shortly after a switching time (“switch_time”). In this example of model 20, desirably a training sequence of ‘0’, ‘1’, ‘0’, ‘1’ . . . signals are transmitted continuously from time 0 of the simulation to switch_time. It is also desirable that the training sequence be transmitted for a continued training time interval following switch_time to allow averaging of the state variable ripple so that switching can occur at the average of the state variable maximum and minimum values. For example, desirably the duration of the continued training time interval is more that one cycle of a “0”, “1” repeating training signal having two bits per cycle. The duration may be a minimum, for example, of two and one-half to three and one-half bits depending on the averaging method of the model and may be longer. After the capacitance value has transitioned to cap_final, in using the model 20, any applicable bit pattern may then be transmitted with the data being captured in the simulation. The simulation time during which the capacitor is not at cap_final may be deemed a first simulation interval. The simulation time following the transition of the simulated capacitor to the cap_final value and while a data bit pattern of interest is being transmitted, may be deemed a second simulation time interval. The first and second time intervals need not be of the same duration and typically the second time interval is much shorter than the first time interval.

The manual capacitor model 20 is identified as the entity cFastSettling in the model. An example of this entity (in VHDL-AMS [IEEE Std. 1076.1]) is described below. Other languages may alternatively be used

| | |
|---|---|
| entity cFastSettling is | |
| generic ( | |
| cap_final : capacitance; | -- Final (nominal) |
| | -- capacitance [F] |
| cap_initia : capacitance := 50.0e−12; | -- Initial capacitance for |
| | -- fast settling [F] |
| switch_time : time := 25 ns); | -- Switching time from |
| | -- cap_initial to cap_final |
| | -- [sec] |
| port ( | |
| terminal p1, p2 : electrical); | |
| end entity cFastSettling; | |

In the architecture of cFastSettling, one or more small values of cap_initial are desirably used to encourage fast settling. In a simplified model, a single value of cap_initial is used throughout the first simulation interval. This simulation model may monitor the state variable (e.g., the across voltage level), or some other state variable in the case of other modeled energy storage components. Desirably, the model transitions to the cap_final value at a time when the simulated capacitor state variable voltage is between maximum and minimum values, such as at the average voltage level. This corresponds to the voltage level being close to the actual dynamic steady-state for the circuit under test when the transition is made to cap_final. This encourages settling of the model.

The architecture of the VHDL-AMS model in which voltage averaging is performed to determine when to transition to the cap_final value is set forth below.

| | |
|---|---|
| architecture voltageAveraging of | |
| cFastSettling is | |
| quantity v across i through p1 to p2; | |
| signal cap_signal : capacitance := | |
| cap_initial; | |
| begin | |
| switch : process is | |
| variable v1, v2 : real; | |
| begin | |
| cap_signal <= cap_initial; | |
| wait for switch_time; | |
| wait until i'above(0.0); | -- First zero |
| | -- crossing rising) |
| v1 := v; | -- Lowest voltage level |
| wait until not i'above(0.0); | -- Second zero crossing |
| | -- (falling) |
| v2 := v; | -- Highest voltage |
| | -- level |
| wait until not v'above((v2 + v1)/2.0); | -- Voltage crossing |
| | -- through average |
| | -- level |
| wait for 1 ps; | -- This helps |
| | -- convergence |
| cap_signal <= cap_final; | |
| wait; | -- forever |
| end process switch; | |
| break on cap_signal; | |
| i == cap_signal*v'dot; | |
| end architecture voltageAveraging; | |

In the above example, when i (the current) is i′ above (0.0), this corresponds to the current just crossing over through zero from a low to a high value and corresponds to the lowest voltage level, indicated as v1 in the model. In the model, the phrase “not i′above (0.0)” refers to the current just crossing through zero from a high to a low value and corresponds to the highest voltage level, which is indicated at v2 in the model. After v1 and v2 have been determined, the model waits until the voltage reaches not v′ above ((v2+v1)/2.0) which corresponds to the voltage having just crossed through the average and thus being substantially at the average voltage value. At this time switching can be made. However, in the above model, desirably one delays switching for a very small amount of time, (e.g., one picosecond), as it has been found that this assists in simulation convergence. The value of the simulated capacitor is then changed to cap_final.

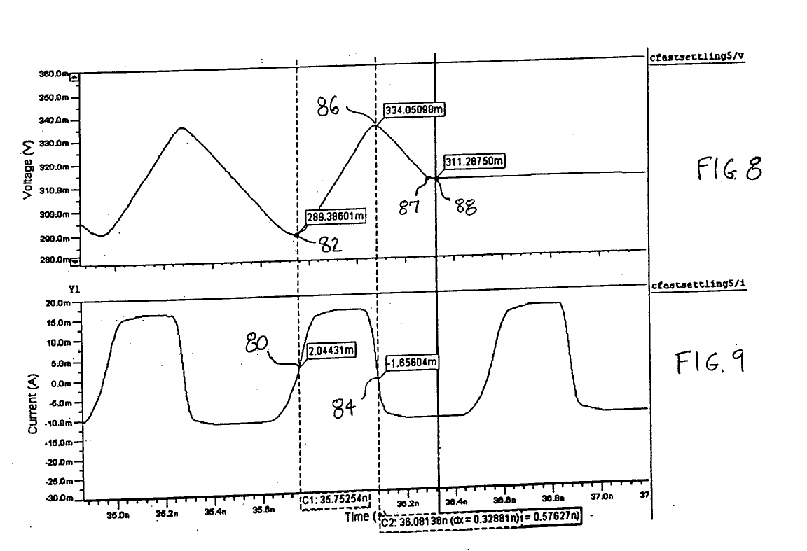

FIG. 7 illustrates the shifting of the capacitance of the simulated capacitor from a fast settling value of 0.1 nanofarads to the simulated design value of 10 nanofarads with the switching taking place at slightly beyond 36 nanoseconds in FIG. 7. FIG. 6 illustrates the settling of the simulated capacitor 22 (FIG. 2) that has taken place immediately prior to and following the transition of the capacitor value to cap_final in this example. FIG. 6 thus shows the ripple voltage across the simulated capacitor. In FIG. 6, the settled voltage is indicated at 0.31114 volts.

FIG. 9 illustrates the transition of the simulated current from a negative value, through zero, and to a positive value with one transition point being indicated at 80 in FIG. 9. This corresponds to the state variable voltage of the simulated capacitor being at a minimum as indicated by point 82 in FIG. 8. In addition, FIG. 9 illustrates a point 84 where the current crosses zero from a positive value to a negative value. This corresponds to the voltage being at a peak as indicated by point 86 in FIG. 8. The transition from a fast settling simulated capacitor value to cap_final occurs at a time indicated by point 87 in FIG. 8. In this example, this transition occurs about when the voltages in FIG. 8 are midway between maximum and minimum values. As a result, convergence to the equilibrium condition is encouraged. This equilibrium voltage is indicated at point 88 in the FIG. 8 example as 311.28750 mV.

As an alternative approach, the model may simply specify a switching time with switching being accomplished after the switching time has elapsed. It is desirable for the fast settling value or values used in the simulation of an energy storage element to be established at a level which has a minimal effect on the operating point of the circuit. In the simulation of FIG. 2, desirably the loading of the switching driver circuit portion should be only slightly affected by use of a particular fast settling value for a capacitor, especially where the driving stage is a highly non-linear circuit. That is, the compression or expansion effect of a load change in a non-linear driver circuit can affect the steady-state or equilibrium operating point of a circuit. One can estimate the change in loading over one switching interval that would occur at a particular reduced value for an energy storage component, in this case the coupling capacitor 22. One can select an initial fast settling value for the energy storage component that is desirably as small as possible (to reduce simulation time for settling), but not so small that it causes a significant “ripple amplitude” in the state variable, and therefore the driver circuit loading. For example, one can select the initial value so that the change in load current is no greater than, for example, five or ten percent of the nominal loading that results from the use of a simulated storage element at the simulated design (final) value. One can also estimate a new faster time constant of the circuit that results from the use of a reduced value or fast settling value of the energy storage element in the simulation. One can then select a value for the switch_time that provides assurance of settling for the circuit reaching the equilibrium operating point. For example, one can choose a value for switch_time that is five times or more larger than the estimated new faster time constant. A smaller margin may also be used.

The above approach is useful in determining initial values and switching times for a “manual” fast settling model particularly for a periodically stimulated circuit. By “manual”, it is meant that the user may designate initial fast settling values and switching times. Models are disclosed below in which an automatic determination of fast settling values and switching times are made. Semi-automatic approaches may also be used (with, for example, the user providing some initial values or otherwise interacting with the model) if desired.

As a specific example, refer to the high-speed digital interconnect of FIG. 1 simulated by the circuit of FIG. 2 with a fast-settling AC coupling capacitor model 20. The driver is switching between zero and two volts in this example every 400 picoseconds. The driver is driving into a 70 ohm transmission line with a 75 ohm termination in this example. Therefore, the current through the simulated capacitor 22 is switching approximately two volts/70 ohms=28.6 mA. Since the voltage across the simulated capacitor 22 is equal to the integral of the current divided by the capacitance, the change in capacitor voltage over one data interval is V_{c}=(400e-12)*(28.6e-3)/cap_initial. In this formula, * refers to multiplication. Assume one desires V_{c} to be approximately ten percent or less of the switching driver voltage in order to not affect the apparent resistive load current of the transmission line and termination, as seen by the drive circuit. In this case, it is desirable for V_{c} to be <0.1*2V=0.2V. Combining these requirements for V_{c}, the result is 0.2 V>(400e-12*28.6e-3)/cap_initial. This means a cap_initial>(400e-12*28.6e-3)/0.2=57.2 pF. In the example of FIG. 7, a 100 pF fast settling value for the simulated capacitor 22 was initially selected for additional margin. For a 100 pF cap_initial, the RC time constant of the circuit is 100e-12*70=7.0 nanoseconds. Five times that time constant is 35 nanoseconds. Thus, a switching time at 35 nanoseconds or greater may be selected. This was done as indicated in FIG. 7.

Thus, one form of manual fast settling capacitor model 20 of FIG. 2 is designed for the user to set the initial capacitance value cap_initial, and the nominal or final capacitance simulation design value (cap_final), it being understood that the final value corresponds to a value for simulation of the design value of the capacitor 16 of FIG. 1. In addition, in this form of model 20, the user selects the time (switch_time) for the simulated capacitor value to be switched (or for switching steps, e.g., averaging, to commence) from the initial to the final value. The training sequence in this example is desirably transmitted for about five time constants from the start of the first simulation interval, after which time the state variable is expected to be settled to steady-state or equilibrium operating conditions. Then, after the model switches to cap_final, the user can start sending any desired data or stimulus pattern for testing.

As another alternative example, cap_initial may be set to be equal to (20*bit.-period)/Reff. In this example, Reff is the effective impedance of the circuit. The “bit-period” refers to the period of the data signal. The factor 20 was selected to result in a ripple of 1/20^{th} (five percent) of the drive voltage. The number 20 can be changed if other values of ripple are acceptable (for example to 10 if a ten percent value is acceptable). Reff is the line, source, or termination impedance. The switch time can then be set to, for example, five time constants: switch_time=5*Reff*cap_initial.

The above manual models may be used in either or both single ended capacitor and differential capacitor applications.

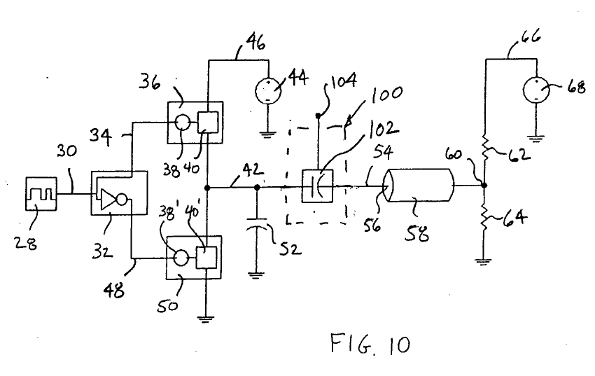

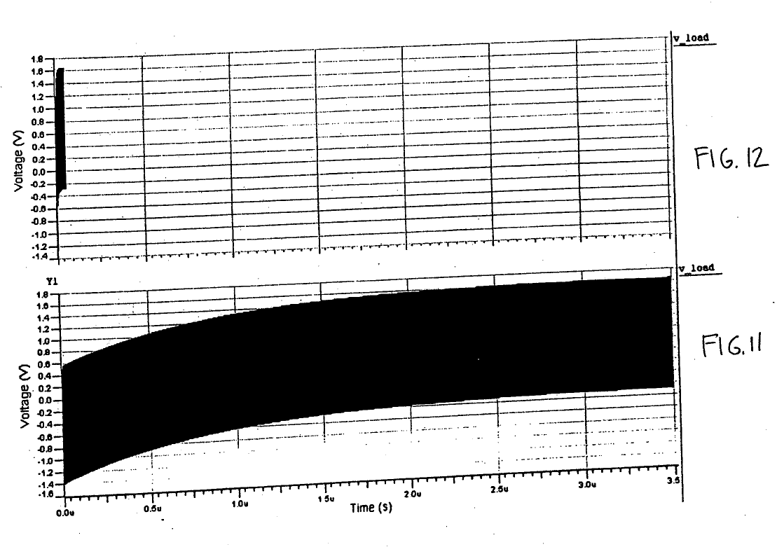

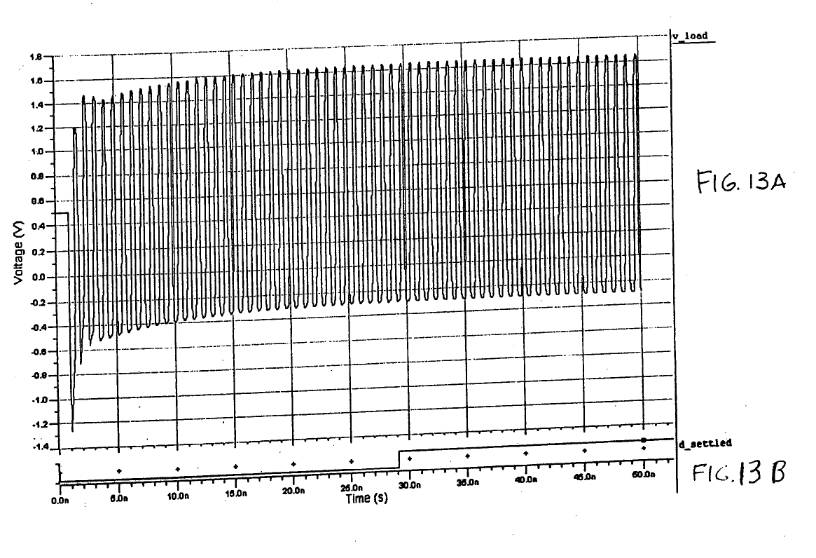

FIG. 10 illustrates an alterative simulation of the circuit of FIG. 1. The simulation of FIG. 10 is identical to that of FIG. 2 except for the form of simulation model 100 in FIG. 10. Simulation components of the FIG. 10 simulation that correspond to those in FIG. 2 have been given the same number as in FIG. 2 and will not be discussed further. The simulated capacitor in the model 100 is indicated at 102. The illustrated model 100 comprises an output 104. Output 104 comprises a settled indication output at which an appropriate signal is provided to indicate that the state variable of the simulated capacitor 102 has settled to the equilibrium output condition. As a specific example, the design value of the capacitor 16 may be 10 nanofarads. The model 100 is an example of a fast settling model which adapts automatically to find suitable fast settling capacitance values and a suitable switching time. In the model used in the example of FIG. 10, a threshold is established for the maximum allowable simulated capacitor state variable (across voltage) ripple during settling. As described below, in a specific illustration, the maximum ripple may be set as 0.1 volts. FIG. 11 is identical to FIG. 3 and is provided as a reference for comparison to FIG. 12. That is, in FIG. 11 a standard simulation model is assumed for the coupling capacitor wherein the capacitance value of the simulated capacitor is set equal to a capacitance value which corresponds to the value required to simulate the design value of the capacitor 16 of the FIG. 1 circuit throughout the entire simulation. Again, this shows that about 3.5 microseconds of simulation time is required for the load voltage to reach steady-state or equilibrium conditions.

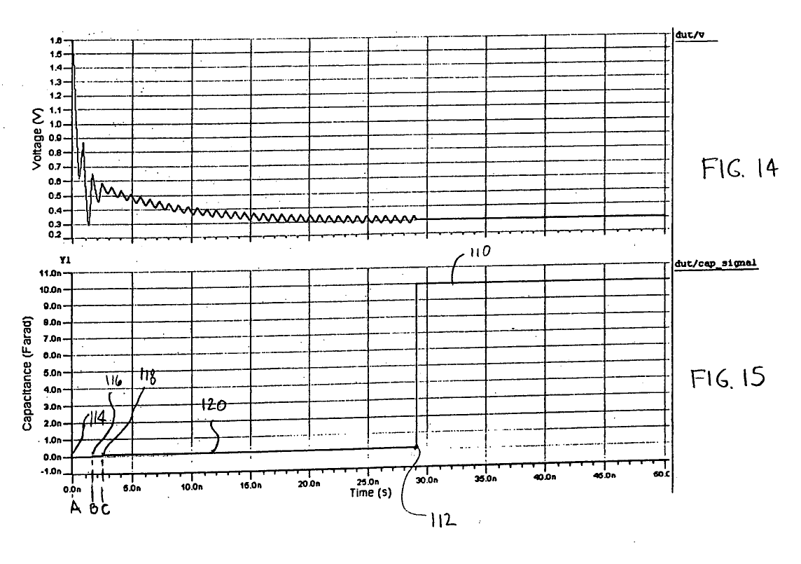

FIG. 12 shows the much faster settling that takes place when a fast settling model 100 is used. FIG. 13A expands a portion of FIG. 12 and shows settling at about 29 nanoseconds of initial simulation time. This compares favorably to the slightly longer settling time in the case of fast settling model 20.

FIG. 13B provides an example of an output at the d_settled output 104 of FIG. 10. Specifically, at about 29 nanoseconds the d_settled output is automatically changed from a logic zero value to a logic one value, although other settling output signals may be used. The model 100 of FIG. 10 desirably automatically shifts the value of the simulated capacitor 102 from a fast settling value to the simulated design capacitance value at the same time as the d_settled indicating signal is set. Alternatively, this signal may be visually displayed to a user of a simulator who is performing a simulation, who then manually shifts the capacitor value and commences the delivery of actual data or stimulus. Alternatively, the d_settled signal may be used to trigger the start of the delivery of actual data, assuming a training sequence has been used during the initial portion of the simulation. The post-equilibrium response of the circuit to the data may then be simulated.

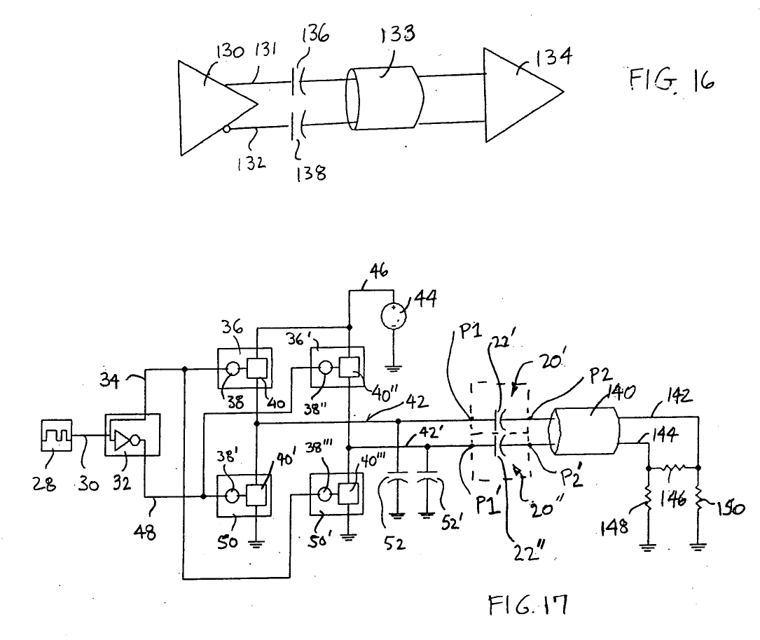

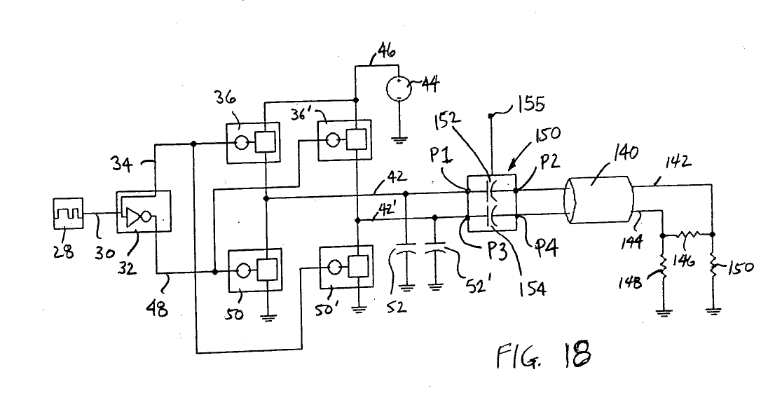

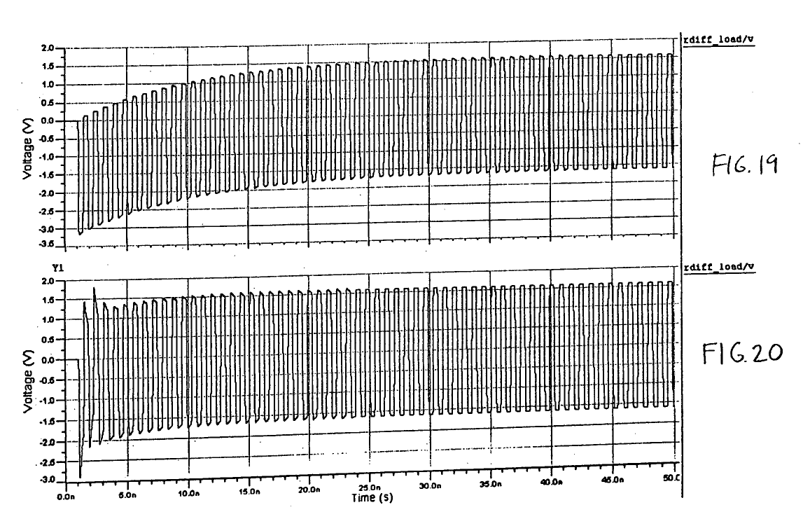

FIG. 14 illustrates the voltage across the capacitor 102 of the model 100. FIG. 15 illustrates the instantaneous capacitance value of the simulated capacitor 102. In this example, the design value is 10 nanofarads and is schematically represented in FIG. 15 by the line 110. The capacitance shifts from a fast settling value to simulating the design value at about 29 nanoseconds in FIG. 15, as indicated at point 112. Initially, the value of the simulated capacitance started at an initial value, indicated by point 114 corresponding to location A along the time scale. The fast settling capacitance is automatically adjusted up and down by model 100 as needed to maintain the ripple voltage (FIG. 14) across the capacitor below a threshold, such as below 0.1 volts peak-to-peak. In this example, at point 116, the initial fast settling capacitance value was adjusted upwardly as the ripple of FIG. 14 was too large with the initially selected fast settling capacitor value. A second adjustment of the simulated capacitor value was made at point 118. The adjustments at points 116 and 118 were made at respective times B and C on the time scale. The point 118 adjustment was to a fast settling capacitance simulated value of 90 picofarads. This latter fast settling capacitance value was used during the remaining time (see line 120) of the first interval of the simulation as the ripple remained within the desired threshold. Then, at point 112, the capacitance was shifted to simulate the nominal or final design value of capacitor 16 of the circuit of FIG. 1.

A specifically desirable application for an automatically adjustable model, such as model 100, for simulating an energy storage element involves the use of the model in a circuit driven by a periodic signal and wherein a consistent training signal or sequence can be applied to the model during the settling window. The “v_ripple” parameter (the maximum allowed ripple or threshold) may be varied. Desirably, v_ripple is specified as ten percent or less of the dynamic range of the switching voltage applied to the modeled energy storage element. For example, if a high-speed data net such as shown in FIG. 1 is being switched between zero and 1.8 volts, then the “v_ripple” parameter for the automatic fast settling capacitor model 100 is desirably set to 0.18 volts or less. As a result, the AC voltage drop across the capacitor will be small in comparison to the voltage swing of the driver circuit. In this case, the capacitor AC voltage drop should not significantly affect the load current and therefore not significantly affect the output characteristics of the drive circuit.

A specific example of the automatically adaptive capacitor model 100 is described below. This illustrated VHDL-AMS model includes a user specifiable variable “v_ripple” which is the maximum (peak-to-peak) ripple voltage across the capacitor 102 during settling. Alternatively, the model itself may set “v_ripple”. This particular capacitor model, when used in an AC coupling application, settles to the dynamic steady-state or equilibrium condition quickly. This is because the simulated capacitance value is automatically adjusted to an initial fast settling value that produces a modest ripple value. The model switches to the simulated design capacitor value, which corresponds to the value used to simulate the design value found in the actual circuit, after the simulated capacitor across voltage has settled to a steady state or equilibrium condition. Desirably, the switching takes place in response to an evaluation of the state variable or ripple voltage across the capacitor such as when the voltage across the simulated capacitor is at the average level of the ripple voltage. This would be very near the dynamic steady-state level. The model 100 in the form shown delivers a d_settled message when the model has reached the settled condition. This message may be delivered to a simulation transcript window. In response, the user of the simulator may commence the simulation using actual data. The model 100 thus automatically shifts the capacitance value from a fast settling value to the simulated design value. Desirably, a training sequence of ‘0’, ‘1’, ‘0’, ‘1’ . . . signals are transmitted to the circuit continuously as a data input from time zero until the capacitor 102 is switched to the final or simulated design value.

The model is assigned an entity identifier as cAutoFastSettling. An example of this entity in VHDL-AMS (other languages may be used) is defined as follows:

Entity cAutoFastSettling is

| | |
|---|---|
| generic ( | |
| cap : capacitance; | -- Nominal capacitance |
| | -- [F] |
| v_ripple : real := 0.1); | -- Maximum allowed |
| | -- voltage ripple during |
| | -- settling |
| port ( | |
| d_settled : out std_logic; | |
| terminal p1, p2 : electrical); | |
| end entity cAutoFastSettling; | |

The architecture of an exemplary VHDL-AMS model 100 is as follows:

```
architecture adaptive of cAutoFastSettling is
  quantity v across i through p1 to p2;
  signal cap_signal : capacitance := cap/1000.0;
begin
process is
  variable v1, v2, v3 : real;
begin
```

| | |
|---|---|
| d_settled <= ‘0’; | -- Start at a factor for 1000 |
| cap_signal <= cap/1000.0; | -- times faster settling |
| wait until i'above(0.0); | -- First zero crossing - |
| | -- rising |
| wait until not i'above(0.0); | -- First zero crossing - |
| | -- falling |
| auto_adapt: loop | -- Loop1 zero crossing - |
| wait until i'above(0.0); | -- rising |
| v1 := v; | -- Lowest voltage level |
| Wait until not i'above(0.0); | -- Loop1 zero crossing - |
| | -- falling |
| v2 := v; | -- Highest voltage level |
| if (v2 − v1 > v_ripple) then | |
| cap_signal <= cap_signal*3.0; | |
| elsif (v2 − v1 < v_ripple/4.0) then | |
| cap_signal <= cap_signal/3.0; | |
| else | |
| exit; | |
| end if; | |
| end loop auto_adapt; | |
| auto_settle: loop | |
| wait until i'above(0.0); | -- First zero crossing - |
| | -- rising |
| v1 := v; | -- Lowest voltage level |
| | -- (first cycle) |
| Wait until not i'above(0.0); | -- First zero crossing - |
| | -- falling |
| v2 := v; | -- Highest voltage level |
| wait until i'above(0.0); | -- Second zero crossing - |
| | -- rising |
| v3 := v; | -- Lowest voltage level |
| | -- (second cycle) |
| if (abs(v1 − v3) < 0.001) then | -- Settled to steady-state |
| wait until not v'above((v2 + v1)/2.0); | -- Voltage crossing through |
| | -- average level |
| cap_signal <= cap; | |
| d_settled <= ‘1’; | |
| report “Settled to dynamic steady-state | |
| at time: ” & real'image(NOW); | |
| exit; | |
| end if; | |
| end loop auto_settle; | |
| wait; | -- forever |
| end process; | |
| break on cap_signal; | |
| i == cap_signal*v'dot; | |
| end architecture adaptive; | |

In the above example, the maximum v_ripple signal has been set at 0.1 but this may be varied. The reference in the model to nominal capacitance is to the final capacitance value of the simulated capacitor which corresponds to the design value of the capacitance of the capacitor in the circuit being simulated.

In the above architecture, although variable, the model sets the initial capacitance value (cap_signal) as equal to the nominal capacitance (cap) divided by 1000. In addition, d_settled is at a logic zero level in this example, indicating that the circuit has not settled. The first portion of the architecture is used in selecting the desired fast settling capacitor simulation value while minimizing the ripple. This is indicated by the auto_adapt:loop which starts after one cycle passes. The simulation waits until the current has just crossed over 0 from negative to positive (i′ above (0.0)). This corresponds to the voltage across the capacitor being at the lowest voltage level (v1). The simulation waits until the current has just crossed zero heading from positive to a negative value (not i′ above (0.0)). This corresponds to the voltage across the fast settling capacitor being at its maximum level (v2). The ripple is then checked by verifying whether v2−v1 is greater than v_ripple. If this is true, then the model determines that the fast settling value of the simulated capacitor is too low. The fast settling value cap_signal is then adjusted, in this case by multiplying the existing cap_signal value by a factor, which in this example is 3. On the other hand, if the difference between v2 and v1 is less than a factor of v_ripple (the factor in this example being a fraction, in this specific case ¼), then a determination is made that the fast settling capacitor value is too high. In this case, the capacitance value is decreased by a factor (in this case 3) and the capacitance iterates toward a desired value.

Optionally, the model may report that the model has found a suitable capacitance value resulting in a satisfactory low ripple.

The auto_settle loop in the architecture provides an example for determining when a simulation has reached a settled condition. In this loop, the lowest level v1 is found in a first cycle in the same manner as v1 is found in the model 20 of FIG. 2. The highest voltage level v2 is then found in the same manner as v2 was found in the model 20 of FIG. 2. In the architecture of the exemplary model 100 set forth above, a second zero crossing of rising current is found for a succeeding cycle, which may desirably be the next cycle. This corresponds to the lowest voltage level v3 of the second cycle. The absolute value of the difference between v1 and v3 is then determined. If this absolute value is less than a threshold, which in the example is set as 0.001, the circuit is deemed settled to a steady-state. Thus, in this example, the difference between two successive minimum voltage levels is obtained and then compared to a threshold. Alternatively, one could examine the difference between successive maximum voltage levels. Alternatively, voltage levels at the same position in successive cycles could be compared to determine whether they are within a threshold. Switching to the simulated design value of the capacitor desirably takes place when the simulated value is midway between the maximum and minimum values, such as at the average value, which may be determined in the same manner as was done in the model 20 of FIG. 2. The d_settled output may be changed to a logic ‘1’ level to report settling of the circuit to the dynamic steady-state or equilibrium condition. In the above example, as an alternative, instead of comparing the difference between v2 and v1 with a v_ripple value to determine the proper selection of a fast settling capacitor simulation value, other techniques may alternatively be used.

FIG. 16 illustrates a schematic diagram of a differential circuit comprising a differential output buffer 130 which produces respective non-inverted and inverted outputs on lines 131,132. These respective outputs pass, by way of a differential transmission line 133, to a differential input buffer 134 which may, for example, be located on a different chip from differential output buffer 130. Respective AC coupling capacitors 136,138 are interposed in respective lines 131 and 132 between output buffer 130 and input buffer 134.

The simulation circuit of FIG. 17 illustrates an exemplary assembly of simulation components for simulating the circuit of FIG. 16. In the FIG. 17 simulation, components which are identical to those in FIG. 2 have been assigned the same numbers (although the voltage at DC voltage source 44 may be different from that of source 44 in FIG. 2). In some cases, a prime (′), double prime (″) or triple prime (′″) designation is used to indicate the replication of identical or like components. In the simulation circuit of FIG. 17, output 42 may be indicated as v_drv_p output. Output 42′ may designated as v_drv_n. The simulation of the transmission line is indicated at 140 and in this example is a symmetric coupled lossless transmission line (real z_odd=50.0; real z_even=70.0). Receiver input 42 may be designated as v_load_p. In addition, receiver input 144 may be designated as v_load_n. Resistors 148,150 and a differential load resistor 146 are also simulated.

In the example of FIG. 17, the respective AC coupling capacitors 136 and 138 of FIG. 16 are each simulated by a manual fast settling capacitor model which is like model 20 discussed above in connection with FIG. 2. Thus, capacitor 136 is simulated by model 20′ with the simulated capacitor component of the model indicated at 22′. In addition, capacitor 138 is simulated by model 20″ with the capacitor component of the model indicated at 22″.

Fast settling simulation values for the respective capacitor components 22′ and 22″ may be determined in the same manner as discussed previously in connection with determining fast settling values for capacitor 22 in the model 20 of FIG. 2. In addition, initial capacitor simulation values and switching times may also be determined in the same manner as discussed above in connection model 20 of FIG. 2.

FIG. 18 illustrates another simulation model for the FIG. 16 circuit. The simulation model of FIG. 18 is identical to that of FIG. 17 except that the dual manual simulation models 20′ and 20″ of FIG. 17 have been replaced by an automatic differential fast settling capacitor model 150 in FIG. 18. The model 150 has a first simulated capacitor 152 that simulates the capacitor 136 in FIG. 16 and a second simulated capacitor 154 that simulates the capacitor 138 in FIG. 16. In FIG. 18 one terminal or pin of simulated capacitor 152 is indicated at P1 and another terminal or pin of this simulated capacitor is indicated at P2. In addition, one terminal or pin of simulated capacitor 154 is indicated as P3 and another terminal or pin of simulated capacitor 154 is indicated as P4. In addition, the model 150 desirably includes an output 155 from which a signal that indicates settling of the capacitors to an equilibrium condition may be indicated. The output 155 may be indicated as d_settled.

The illustrated model 150 operates as a control/controlled pair of simulated capacitors in that the capacitance adjustment process in the model is controlled by only one of the simulated capacitors (the control capacitor), with adjustment of the other capacitor (the controlled capacitor) following or tracking the adjustment of the control capacitor. This approach prevents undesired adaptation-interactions that could occur if two independent automatic fast settling capacitors were used in a coupled circuit like in this example.

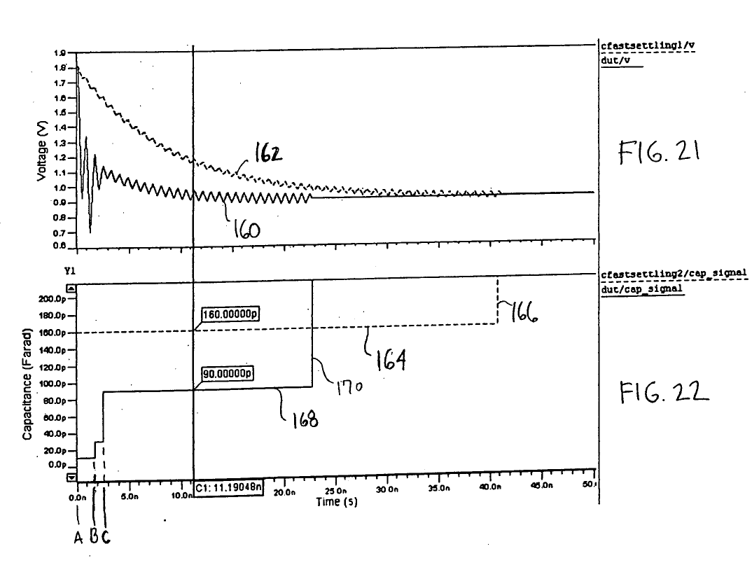

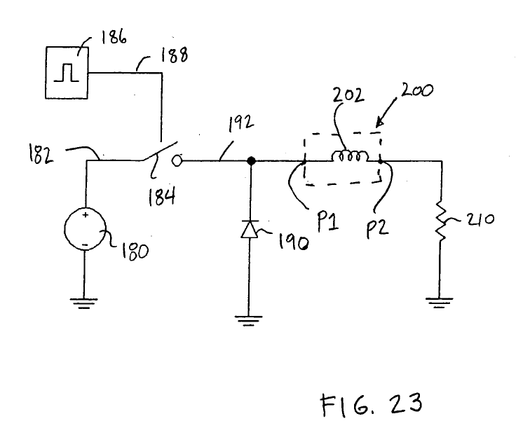

FIG. 19 illustrates the differential load voltage settling response for the model of FIG. 17 utilizing two manual capacitor models 20′,20″ like model 20 of FIG. 2. FIG. 20 illustrates the differential load voltage settling response for the automatic differential capacitor model 150. In the comparison of FIGS. 19 and 20, the automatic differential capacitor model 150 has settled faster, but this is not always the case. FIG. 21 illustrates a comparison of the internal signals across capacitors utilizing automatic and manual differential capacitor models. The graph of FIG. 21 shows the ripple voltage across the capacitors with the solid line in FIG. 21 (indicated at 160) corresponding to the ripple voltage present (at simulated capacitor 152, FIG. 18) in the case of one example of the automatic model 150. The dashed line (indicated at 162 in FIG. 21) illustrates the ripple voltage across a capacitor (22′ or 22″, FIG. 17) when the manual models are used for the capacitors. As can be seen in FIG. 21, the ripple is somewhat larger for the automatic model, especially in the beginning of the simulation. However, in the automatic model, the ripple voltage settles more quickly.

The graph of FIG. 22 shows the adjustment of capacitance values in the manual and automatic modeling examples. In FIG. 22, the dashed line illustrates that each of the simulated capacitors 22′,22″ of the manual models 20′ and 20″ of FIG. 17 start with an initial fast capacitance value of 160 picofarads as indicated by dashed line 164 in FIG. 22. At about 41 nanoseconds, the simulated capacitor values of 22′ and 22″ are adjusted to their design values as indicated by the vertical portion 166 of the dashed line in FIG. 22. The design values of the capacitors 22′,22″ is 10 nanofarads and is off the scale in FIG. 22. In contrast, the adjustment of the simulated capacitor values in the automatic differential capacitor models is indicated by the solid line 168 in FIG. 22. The initial value of 10 picofarads for the controlling (and thus the controlled) simulated capacitor 152 (FIG. 18) in the automatic model of FIG. 22 was established at time A along the time scale and was initially too low. A first adjustment (to 30 picofarads [3*10 pf]) in value was made at time B along the time scale and a third adjustment in value (to 90 picofarads [3*30 pf]) was made at time C. The fast settling capacitance value for the controlling simulated capacitor 152 was at 90 picofarads for the bulk of the initial simulation time interval. At about 23 nanoseconds, as indicated by the vertical component 170 of the solid line graph in FIG. 22, the capacitance of the control simulated capacitor (e.g., 152 in FIG. 18) was adjusted to its design value of 10 nanofarads (off the scale in this figure) with the capacitance of the simulated controlled capacitor (e.g., 154 in FIG. 18) also being simultaneously adjusted to its design value. More aggressive (e.g., smaller) initial settings could also have been selected as the fast settling capacitance values for the manual models making the manual models settle more quickly. However, in either of these examples, the settling occurred at times that were orders of magnitude faster than an example in which simulation capacitors are simply set at the simulation design value throughout the simulation.

A specific example of an automatic differential capacitor pair simulation model is set forth below. In this model, the user may specify a maximum peak-to-peak ripple voltage across the capacitors during settling, this maximum being called “v_ripple”. The model 150 has two capacitors for a differential pair application. Although either of the capacitors 152 or 154 may be selected as the controlling or control capacitor, in this example, the simulated capacitor 152, between P1 and P2, is the control capacitor while the simulated capacitor 154, between P3 and P4, is the controlled capacitor. This example of the model 150 settles to the dynamic steady-state quickly because the capacitance automatically adjusts to an initial fast settling with modest ripple value. The model then switches to the actual nominal or design simulation capacitor values after the system has settled to an equilibrium condition. Desirably, switching occurs at a capacitor state variable level which is between the maximum and minimum across voltage levels such as at the average level of the control capacitor state variable in the example explained below. This would be very near the dynamic steady-state level. The exemplary model 150 delivers an output at 155 (FIG. 18) to indicate that the model has reached the settled value. This output may be used, for example, in the same manner as the “d_settled” output discussed above in the model 100 of FIG. 10. Desirably, a repetitive sequence of training signals is delivered to the circuit during settling such as alternating logic ‘0′’ and logic ‘1′’ value signals. The training sequence may be delivered continuously from time 0 until the simulated capacitors switch to their simulated design values.

The model 150 may be identified as cDiffAutoFastSettling. Although other languages may be used, the entity may be defined in VHDL-AMS as follows:

Entity cDiffAutoFastSettling is

| | |
|---|---|
| generic ( | |
| cap : capacitance; | |
| | -- Nominal capacitance [F] |
| v_ripple : real := 0.1); | -- Maximum allowed voltage ripple |
| | -- during settling |
| port ( | |
| d_settled : out | |
| std_logic; | |
| terminal p1, p2, p3, p4 | |
| : electrical); | |

end entity cDiffAutoFastSettling;

The architecture of one form of cDiffAutoFastSettling is set forth below in VHDL-AMS format. This model is easily understood with reference to the description of the automatic capacitor model cAutoFastSettling 100 set forth above and hence will not be discussed further. The architecture of the exemplary model in VHDL-AMS is set forth below:

| | |
|---|---|
| Architecture adaptive of | |
| cDiffAutoFastSettling is | |
| quantity v across i through p1 to p2; | |
| quantity v34 across i34 through p3 to p4; | |
| signal cap_signal : capacitance := | |
| cap/1000.0; | |
| begin | |
| process is | |
| variable v1, v2, v3 : real; | |
| begin | |
| d_settled <= ‘0’; | |
| cap_signal <= cap/1000.0; | -- Start at a factor for |
| | -- 1000 times faster |
| | -- settling |
| Wait until i'above(0.0); | -- First zero crossing - |
| | -- rising |
| Wait until not i'above(0.0); | -- First zero crossing - |
| | -- falling |
| auto_adapt: loop | |
| wait until i'above(0.0); | -- Loop1 zero crossing - |
| | -- rising |
| v1 := v; | -- Lowest voltage level |
| wait until not i'above(0.0); | -- Loop1 zero crossing - |
| | -- falling |
| v2 := v; | -- Highest voltage level |
| if (v2 − v1 > v_ripple) then | |
| cap_signal <= cap_signal*3.0; | |
| elsif (v2 − v1 < v_ripple/4.0) then | |
| cap_signal <= cap_signal/3.0; | |
| else | |
| exit; | |
| end if; | |
| end loop auto_adapt; | |
| auto_settle: loop | |
| wait until i'above(0.0); | -- First zero crossing - |
| | -- rising |
| v1 := v; | -- Lowest voltage level |
| | -- (first cycle) |
| wait until not i'above(0.0); | -- First zero crossing - |
| | -- falling |
| v2 := v; | -- Highest voltage level |
| wait until i'above(0.0); | -- Second zero crossing |
| | -- rising |
| v3 := v; | -- Lowest voltage level |
| | -- (second cycle) |
| If (abs(v1 − v3) < 0.001) then | -- Settled to steady- |
| | -- state |
| Wait until not v'above((v2 + | -- Voltage crossing |
| v1)/2.0); | -- through average level |
| cap_signal <= cap; | |
| d_settled <= ‘1’; | |
| report “Settled to dynamic steady- | |
| state at time: ” & real'image(NOW); | |
| exit; | |
| end if; | |
| end loop auto_settle; | |
| wait; | -- forever |
| end process; | |
| break on cap_signal; | |
| i == cap_signal*v'dot; | |
| i34 == cap_signal*v34'dot; | |
| end architecture adaptive; | |

To illustrate the versatility of the fast settling technology disclosed herein, FIG. 43 illustrates an application of the automatic differential fast settling capacitor 150 (described above in connection with FIG. 18) in a multi-gigabit serial data transmission application, such as in a peripheral component interconnect application, operating at 2.5 gigabits per second. The driver 400 in this example is referenced to a 2.5 volt supply and the receiver 402 in this example is referenced to 0.75 volts. For this reason, an AC coupling (series) capacitor model 150 is included in the differential signal path. A simulated lossy transmission line 404 is interposed between model 150 and receiver 402.

Initially in this example, the d_settled output 155 of the fast settling capacitor model 150 is at a logic level ‘0′’. This controls a multiplexer 406 model included in the simulation to receive a training sequence input from a training data source 408 instead of from an actual data source 410 (such as a pseudorandom bit stream ([PRBS)]). As explained above, the training data source may deliver a training sequence such as a repetitive alternating sequence of logic ‘1′’ and logic ‘0′’ bits to the driver 400 until the state variables of the capacitor model 150 reach a steady-state or equilibrium condition. When this occurs, the d_settled output 155 in this example is changed to a logic level 1. This switches the multiplexer 406 to receive data or stimulus from the PRBS data source 410. This latter data may, for example, comprise a data pattern that is used for signal quality verification at the receiver 402. In a conventional manner, an “Eye-Diagram” is used to quantify the signal. Often, 250 bits of data or more are overlaid and compared to produce an Eye-Diagram. To simulate these 250 bits of PRBS data, the simulation may be continued for another 100 nanoseconds (250*400 ps) after the simulation capacitors 152,154 of model 150 have changed to their simulated design values.

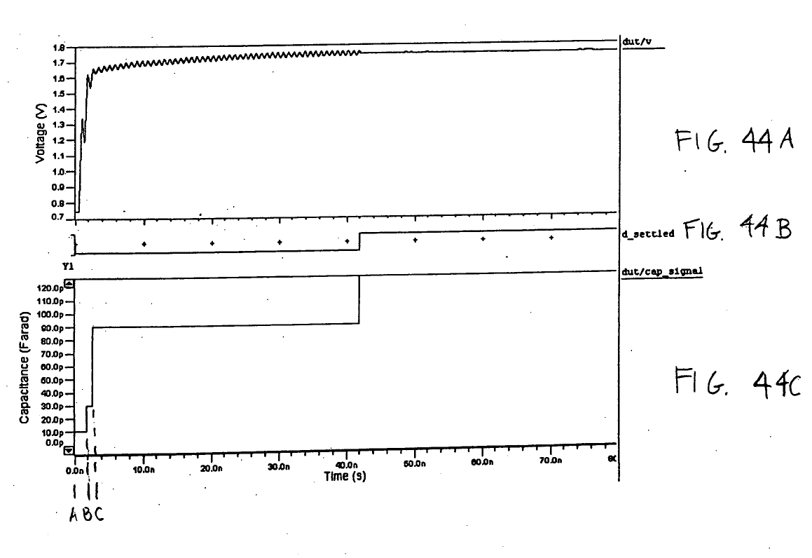

FIG. 44A illustrates a graph of the simulated voltage across one capacitor leg of the model, such as across simulated capacitor 152. FIG. 44A illustrates the ripple voltage and the fast settling of the capacitor output to a steady-state. FIG. 44B illustrates the d_settled logic output signal. In this figure, the transition occurs at roughly 42 nanoseconds. FIG. 44C illustrates the capacitance value of the simulated capacitor 152 (and thus of the controlled capacitor 154 in this example). The fast settling capacitance value is adaptively selected in this example during the settling time (the value being changed at times A, B and C in the simulation to a final 90 picofarad fast settling value) before switching to the nominal or design simulation value of 10 nanofarads (off the scale in FIG. 44C) in this specific example.

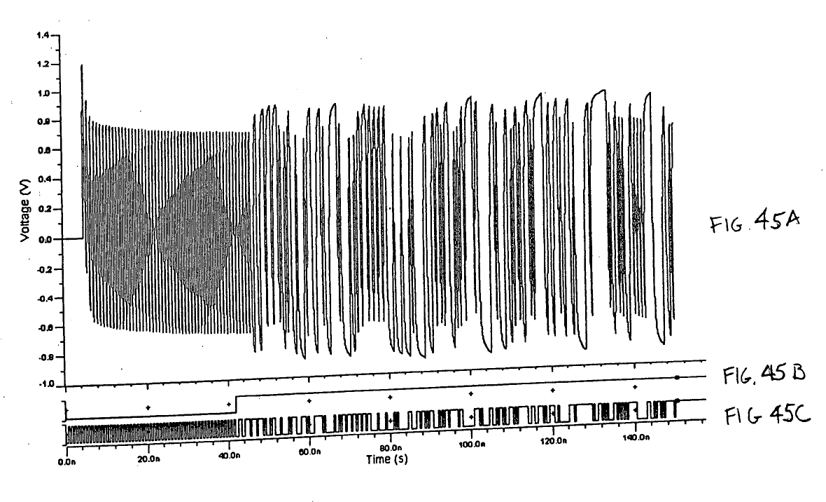

FIG. 45A illustrates the differential voltage at the receiver 402 in the simulation of FIG. 43. Initially, the voltage has a regular form arising from the transmission of the exemplary training data sequence. This regular form becomes irregular upon the arrival of the PRBS data. FIG. 45B illustrates the d_settled signal change.

FIG. 45C illustrates the transmission of exemplary actual data or stimulus. Comparing FIG. 45C and FIG. 45A shows a delay in the transition in the voltage at receiver 402 from the regular form shown in the first (left side) portion of FIG. 45A to the irregular form shown in a second (right side) portion of FIG. 45A relative to the time at which delivered data (FIG. 45C) transitions from the training sequence to the actual data sequence. This delay corresponds to the delay of the transmission line 404 in the simulation.

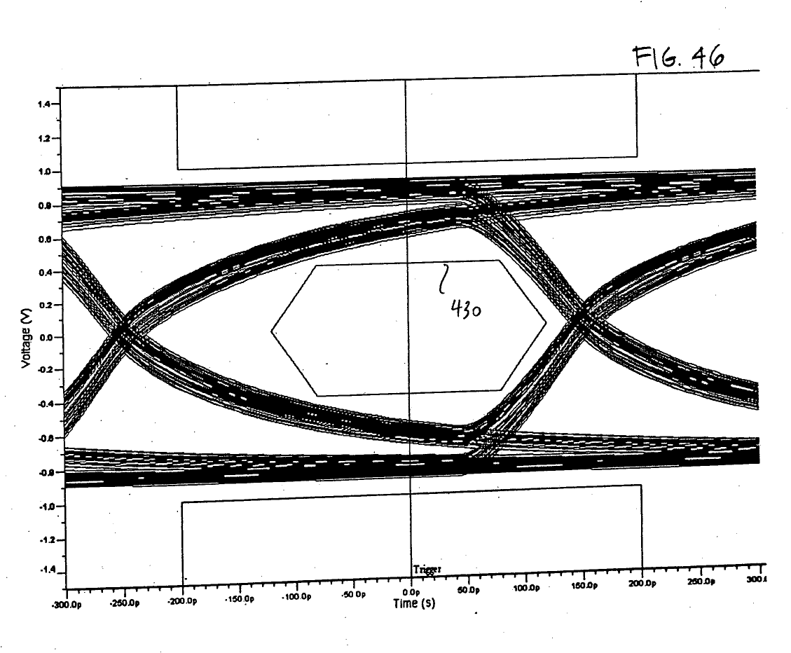

FIG. 46 illustrates the Eye-Diagram resulting from overlaying 250 databits that were received in the final 100 nanoseconds of the simulation (following settling and for 100 ns of PRBS data). The mask 430 in this figure represents the “stay-out” specification limits for satisfactory signal quality. The more “open” the Eye (e.g., the larger the margin from the data “touching” the mask), the better the signal quality.

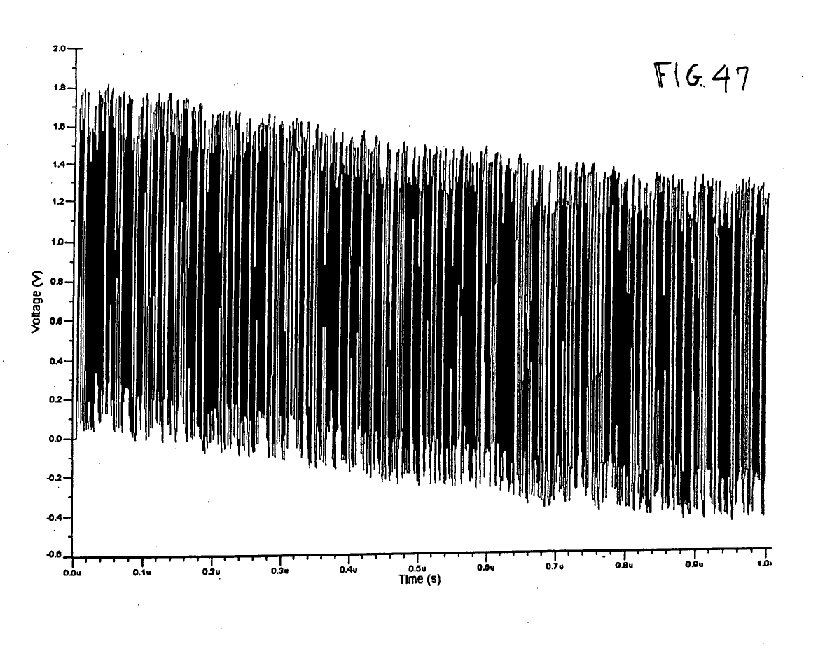

FIG. 47 illustrates the differential receiver 402 voltage for 1000 nanoseconds of simulation using simulation capacitors that have values fixed at the design value of 10 nanofarads so as to correspond to the nominal circuit design value of 10 nanofarads in this example. After 1000 nanoseconds of simulation, the voltage has not settled and will not be settled for a much longer simulation time than the simulation time depicted in FIG. 47. The downward drift in the voltage in FIG. 47 indicates that this is an unsettled condition.

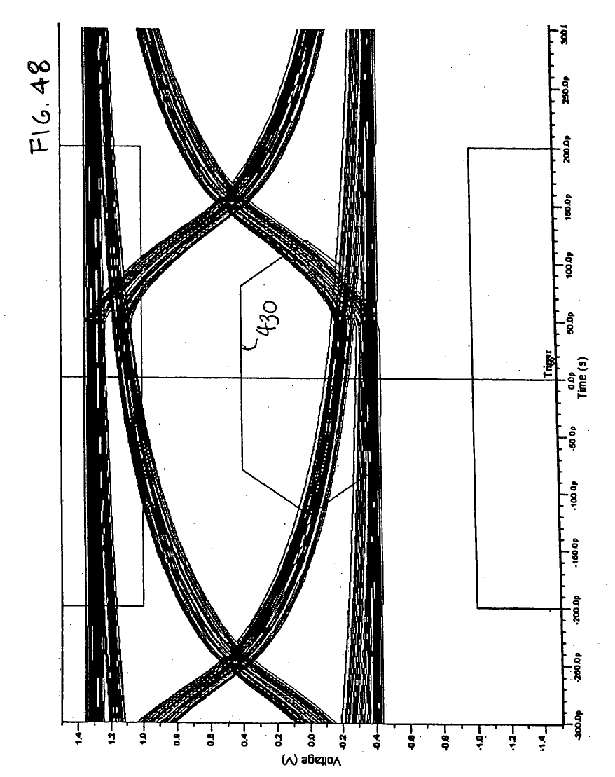

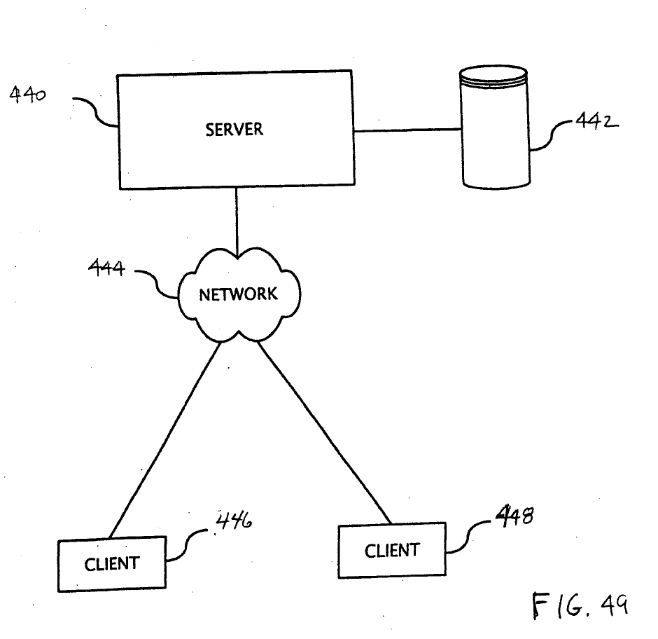

FIG. 48 is an Eye-Diagram of the last 100 nanoseconds of the unsettled data of FIG. 47. In FIG. 48 it is apparent that the Eye is not centered on the specification mask 430. It is not possible to fix this lack of centering by simply shifting the mask upwardly in FIG. 48 because the data does not represent a fixed offset. Instead, there is a drift over time as a result of the unsettled data condition. This drift smears the Eye and corrupts the measurement of the Eye opening.

With reference to FIG. 23, the fast settling techniques of this disclosure are illustrated in connection with another form of energy storage element, namely an inductor. FIG. 23 illustrates a simulation application of a fast settling inductor model in a switching DC to DC power converter circuit. In the model of FIG. 23, a simulated DC voltage source 180 is shown that may, in the example, be set at 14 volts DC. A voltage source line 182 (v_src) is coupled from source 180 to a switch model 184. The switch model SW1 may have the following characteristics: resistance r_open=10.0 e3; resistance r_closed=10.0 e-3; and real trans_time=1.0 e-6. The transition time refers to the time to close or open the switch. The switch is opened and closed in response to digital pulses from a source 186 coupled by a control line 188 (d_sw) to simulated switch 184. As a specific example, the characteristics of source 186 may be: dig_pulse; real duty=0.41; and delay_length period 100 microseconds. The simulated circuit includes a diode 190 (d1) coupled to a line 192 (v_diode) which is also coupled to switch 184. Line 192 is coupled to a fast settling inductor model 200 having a terminal P1 coupled to line 192 and a terminal P2 coupled through a resistor 210 to ground. In this example, resistor 210 may be designated r1 with resistance res=1.0 ohm. Model 200 comprises a simulated inductor 202 between terminals P1 and P2. In this example, assume the final design value of the inductor in the circuit being simulated is 10.0 e⁻³ Henry. Thus, the final simulated design value (inductance ind_final=10.0 e-3) is a value which simulates the design value of the inductor in the circuit being simulated. One or more fast settling inductance values are initially adopted. For example, an initial inductance value may be set equal to 1.0 e⁻³ Henry (inductance ind_initial=1.0 e-3). In addition, a simulation time at which switching of the inductance from a fast settling value to a simulated value takes place may be designated as the switch_time. In one specific example switch_time=9.0 milliseconds.

The power converter simulated in FIG. 23 has a “buck” topology, and is designed to reduce the 14 volt DC input to a 5 volt DC output (i.e., across the 1.0 ohm load resistor 210 in this example). The switch 184 in this example may be a periodic switch operating at 10 kilohertz with a 41 percent duty cycle. Ideally for a “buck” converter Vout=(duty cycle)*Vin. This implies that a 35.7 percent duty cycle would be needed to convert 14 volts to 5 volts. However, because of non-linear behavior of the free-wheel diode and switch parasitic effects, the actual required duty cycle is different. Simulation-based “trial-and-error” simulations with various values typically would be needed to find the correct duty-cycle for this non-ideal system. The large inductor value (10 millihenrys) produces a long circuit time constant (the time constant equals L/R=10.0 e-3/1.0=10 milliseconds). The simulation time required to reach the settled steady-state state variable level is prohibitive, because of the fast switching frequency (e.g., 10 KHz). The use of a fast settling model 200 for an inductor substantially reduces this simulation time.

In the above power converter example, approximately (14V−5V=9V) is switched across the inductor when the switch is opened and closed (ignoring the small diode drop). With a duty cycle of approximately 40%, the “on” interval is 0.40*100 usec=40e-6 sec. Since the current through the inductor is equal to the integral of the voltage across it, divided by the inductance, the change in current over one data interval is iL=40e-6*9/ind_initial. At steady-state, the load current is 5 amps (=5V/1 ohm). Assume that, although this may be varied, a desirable maximum ripple current is to be less than 10% of the operating load current. In this case, the current change over one switching interval should be iL<0.1*5=500 mA. Combining these requirements for iL results in ind_initial>40e-6*9/0.500=0.72 mH. Based on this information, a suitable initial fast settling inductance would be 1 mH. The time constant for a 1 mH initial inductance with a load resistor of 1 ohm is L/R=1 msec. By selecting a switch_time of at least five time constants (although this can be varied), there is assurance that settling of the state variable (e.g., through current) to an equilibrium or steady-state condition will have been achieved at the time the simulated capacitor value is shifted to the final simulated design value. This one possible switch_time is after five time constants=5 msec, or more. In this specific example, 9 msec is selected.

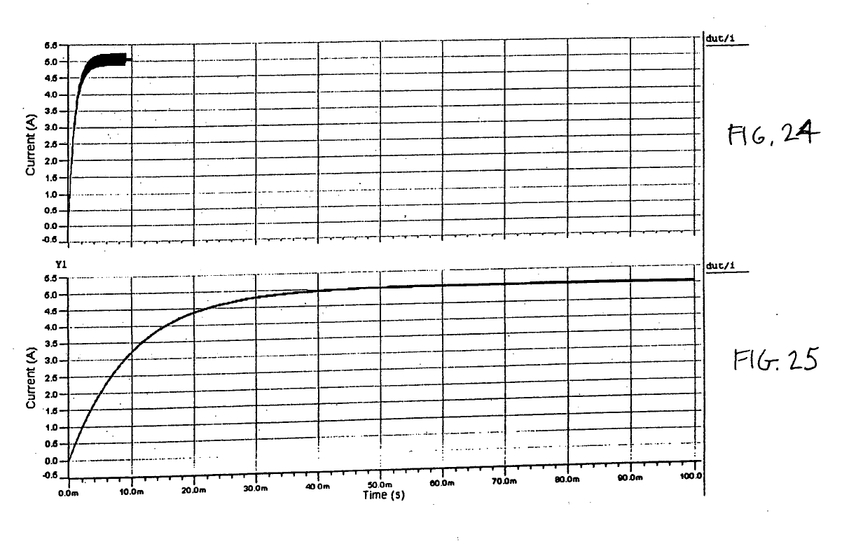

FIG. 24 illustrates the inductor current for a fast settling inductor model 200 in the FIG. 23 simulation, with an initial fast settling inductance value of the inductor 202 at 1 millihenry. The inductor in this example is switched to the simulated design or nominal inductance value of 10 millihenrys after 9 milliseconds. The simulation is then run for a second simulation time interval of 1 millisecond longer to collect settled steady-state inductor current waveform data. In contrast, FIG. 25 depicts the inductor current in a simulation in which the simulation inductor is at the nominal or design inductance value of 10 millihenry throughout the entire simulation. As indicated in FIG. 25, a substantial amount of time is required for the simulated circuit under these latter circumstances to settle to an equilibrium or steady-state.

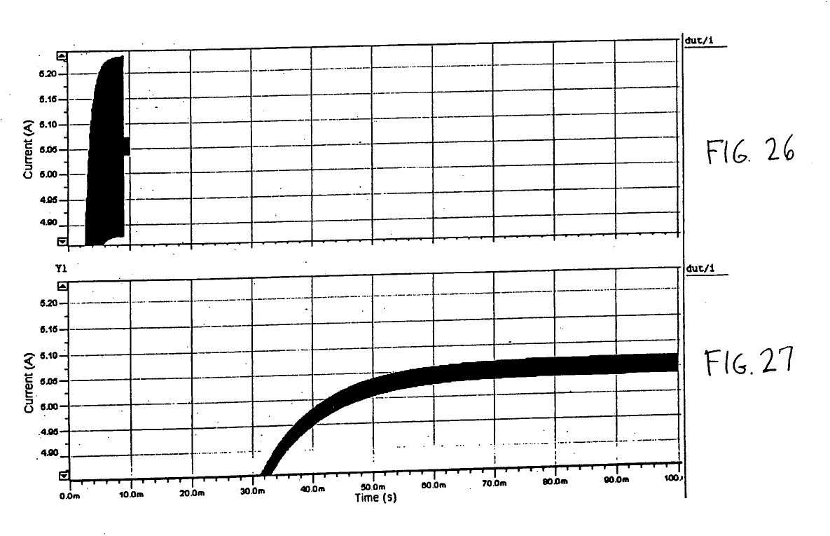

FIG. 26 corresponds to FIG. 24 and is more specifically a zoomed-in view (in the y-axis only) of a portion of the FIG. 24 inductor current utilizing the fast settling model 200. FIG. 27 shows, for purposes of comparison, a zoomed-in view (in the y-axis only) of a portion of the inductor current of FIG. 25. In both cases, the average settled current level is 5.05 amps corresponding to an output voltage of 5.05 volts with a load resistance of 1.0 ohms. Thus, both the fast settling model and conventional slow model (where the inductance value is maintained constant throughout the simulation) settle at the same level. This confirms the operability of the fast settling model.

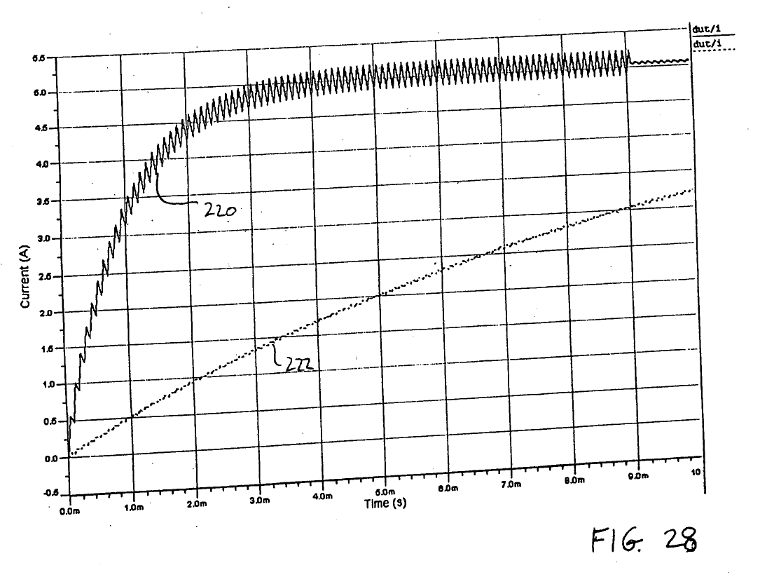

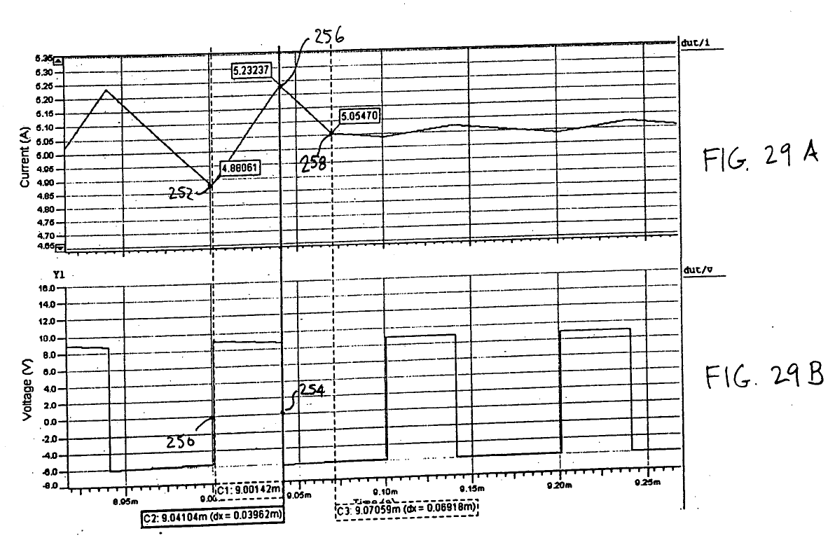

FIG. 28 depicts a zoom view (in the x-axis only) of portions of the inductor currents shown in FIGS. 24 and 25. The graph 220 in FIG. 28 corresponds to a portion of the data from FIG. 24 generated when a fast settling inductor model 200 is used. The dashed line graph 222 in FIG. 28 corresponds to a portion of the data from FIG. 25 and again illustrates the much slower settling that takes place without a fast settling model. In the fast settling inductor model 200, switching from the fast settling inductance value to the simulated design inductance value desirably is accomplished when the simulated state variable is between minimum and maximum current values, such as at the average of these values.

FIG. 29B illustrates voltages across the inductor with zero voltage crossings (from negative to positive and positive to negative) corresponding to respective minimum and maximum through terminal current ripple values. For example, zero crossing point 250 from a negative voltage to a positive voltage in FIG. 29B corresponds to the minimum ripple current indicated at point 252 in FIG. 29A. In contrast, zero crossing point 254 from a positive voltage to a negative voltage in FIG. 29B corresponds to a maximum ripple current indicated at point 256 in FIG. 29A. Thus, voltage crossings can be used to determine minimum and maximum current ripples. Switching from a fast settling to a design simulation inductance values desirably takes place at a point between the minimum and maximum current ripple values, such as at point 258 in FIG. 29A. Point 258 corresponds to an average of these minimum and maximum ripple current values. Following switching, the circuit continues to operate substantially at an equilibrium condition as indicated by the portion of the graph in FIG. 29A to the right of point 258.

A specific example of one form of a fast settling inductor model for periodic switching applications is set forth below. The model transitions to a dynamic steady-state current or equilibrium condition quickly because of the transitioning of the simulated inductance value from a much smaller initial value (ind_initial) to a simulated nominal or design inductance value (ind_final). The transition in simulated inductor values takes place shortly after a switching time (switch_time).

Although, as in the case of other models, any suitable language may be used, in this example, the model may be identified as L_FastSettling with the entity being described in VHDL-AMS format as follows:

| | |
|---|---|
| entity L_FastSettling is | |
| | -- Nominal inductance (H) |
| generic ( | |
| ind_final : inductance; | |
| ind_initial : inductance; | -- Initial inductance (H) |
| switch_time : time); | -- Switching time from ind_initial |
| | -- to ind_final [sec] |
| port ( | |
| terminal p1, p2 : electrical); | |
| end entity L_FastSettling; | |

An example of an architecture for this entity is set forth below using VHDL-AMS. The exemplary architecture allows a smaller value of ind_initial to be used because the exemplary model identifies the average current level during switching, and transitions to ind_final at the moment when the current is at the average. This approach is desirable because the average current level would be close to the actual dynamic steady-state for the circuit under test. Switching may be accomplished at other simulation times.

| | |
|---|---|
| architecture currentAveraging of | |
| L_FastSettling is | |
| quantity v across i through p1 | |
| to p2; | |
| signal ind_signal : inductance | |
| := ind_initial; | |
| begin | |
| switch : process is | |
| variable i1, i2 : real; | |
| begin | |
| ind_signal <= ind_initial; | |
| wait for switch_time; | |
| wait until v'above(0.0); | -- First voltage zero crossing |
| | -- (rising) |
| i1 := i; | -- Lowest current level |
| wait until not v'above(0.0); | -- Second voltage zero crossing |
| | -- (falling) |
| i2 :=i; | -- Highest current level |
| wait until not i'above | -- Current crossing through |
| ((i2 + i1)/2.0); | -- average level |
| wait for 1 ps; | -- This helps convergence |
| ind_signal <= | |
| ind_final; | |
| wait; | -- Forever |
| end process switch; | |
| break on ind_signal; | |
| v == ind_signal * i'dot; | |
| end architecture currentAveraging; | |

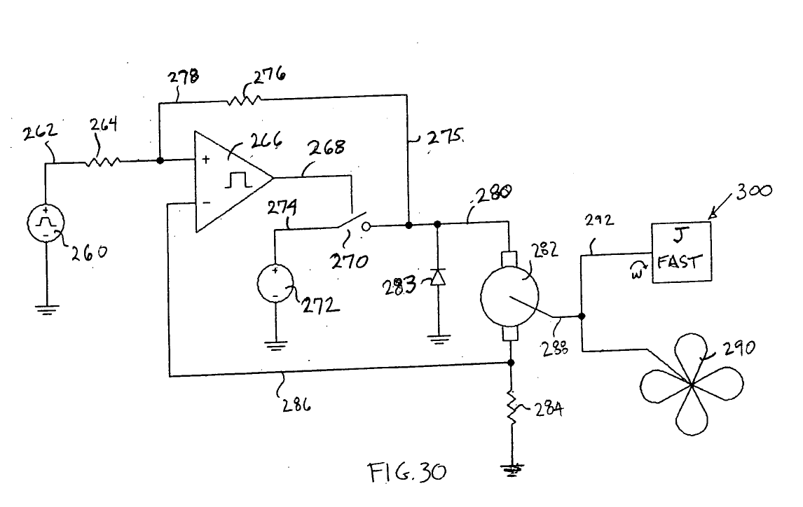

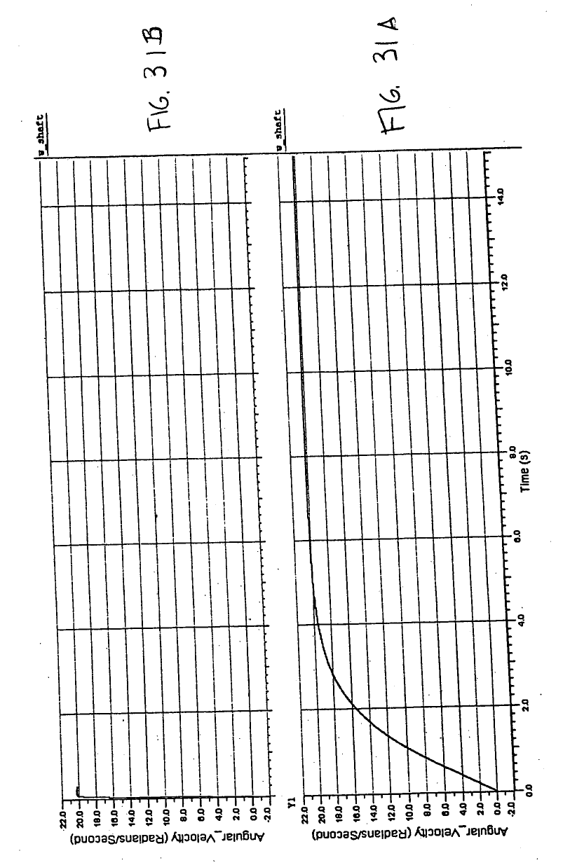

With reference to FIG. 30, an example of the fast settling technology is illustrated in the mechanical domain. More specifically, FIG. 30 illustrates a simulation circuit having a fast settling inertia model for a current-controlled motor drive in a fan application. In the simulation of FIG. 30, the simulation components are identified as follows: A voltage pulse source 260 that sets the command current level (e.g., a voltage level of 10 volts, that corresponds to a current level of 10 amps in this example, is the command input to a switching current controller); a command current line 262 (v_icmd); resistor 264 (R2); comparator 266 (U1); a switch controlling output line 268 (d_switch); a switch 270 (SW1); a DC voltage source 272 is set to 12V, and is coupled by a line 274 (v_bat) to one terminal of the switch 270; positive feedback is provided along a line 275 through a resistor 276 (R3) coupled via a line 278 (v_comp_p) to the positive input of comparator 266. This feedback provides hysteresis. The other terminal of switch 270 is coupled via a line 280 (v_motor) to a DC motor 282. This switch output is also coupled to one side of a diode 283. A motor current sense resistor 284 is coupled to motor 282. The motor current is sensed as a voltage across the sense resistor 284, with this sensed signal being delivered by a line 286 (v_isense) to the negative input of comparator 266. The motor 282 is coupled by a shaft 288 to the wind drag effects of a fan 290. A model 300, in this case a fast settling model, is provided to model the inertia of the shaft and fan load and is shown coupled by a line 292 (w_shaft) to the motor and fan.

In the simulation circuit of FIG. 30, the comparator opens and closes switch 270 in response to the error between the commanded and actual current level. When the switch 270 closes, in this example, 12 volts DC is applied across the motor. There is no synchronous or externally-set current switching frequency. Instead, the internal inductance of the motor (for example, 10 mH) and back-EMF voltage determine when the current will reach the comparator switching thresholds. In this example, the frequency actually changes based on motor speed. The motor drives a fan load which includes a large inertia (e.g., 0.1 Kg-m²). The fan load is non-linear so that the concept of a linear system time constant does not apply readily in this application. However, it typically takes a significant amount of time for an actual fan of this type to settle to its operating speed. Therefore, it would require a significant simulation time for a simulation using the nominal or design inertia value throughout the entire simulation to settle to an equilibrium operating condition. The simulation time required to reach this dynamic steady-state is reduced in this example by using the fast settling inertia model 300 depicted in FIG. 30. Thus, a fast settling model is operable even in a non-periodic system.

FIG. 31A illustrates the fan/motor shaft speed in the simulation (radians/sec) for a simulation using a constant simulated inertia of 0.1 Kg-m², that matches the nominal or design value, throughout the entire simulation. As is apparent from FIG. 31A, a substantial amount of time is required for the fan/motor shaft speed to settle to its steady-state operating condition.

FIG. 31B illustrates fan/motor shaft speed using a fast settling model in a simulation in which a fast settling initial inertia value of 0.001 Kg-m² was used prior to shifting the inertia value in the simulation to the design value of 0.1 Kg-m². The switching time was 0.15 seconds in this example.

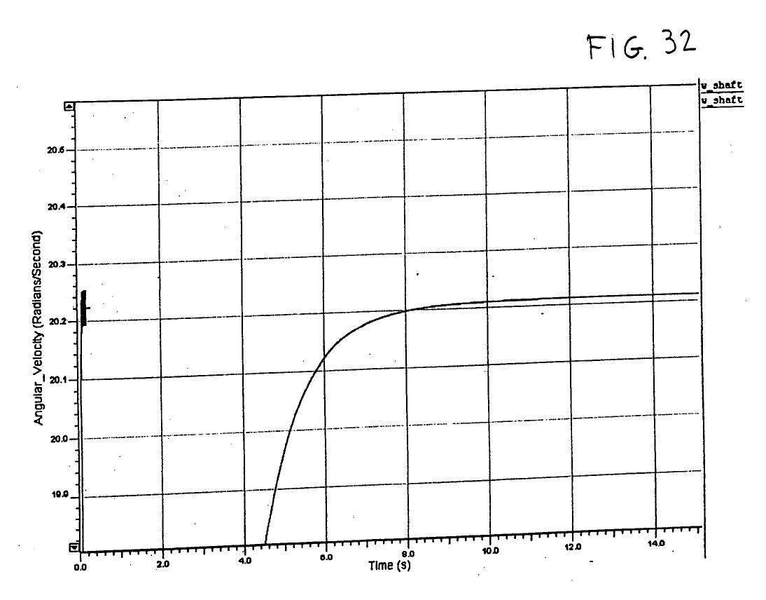

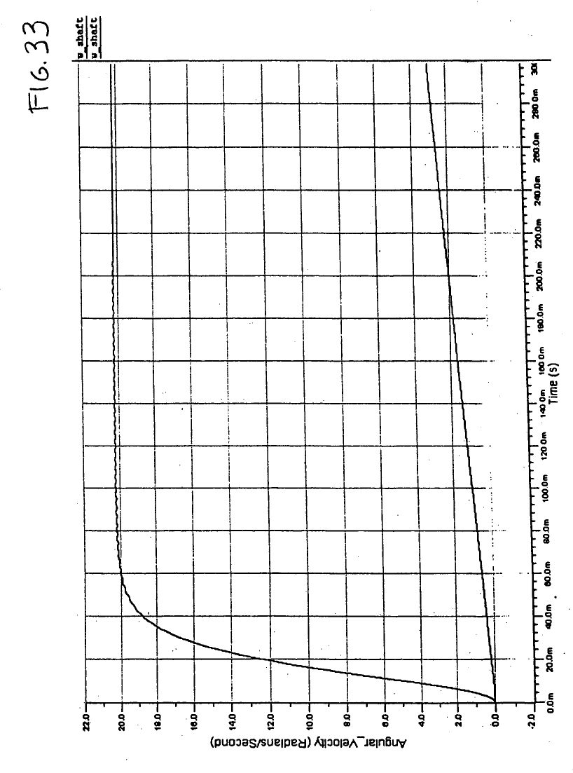

FIG. 32 is a zoom view (y-axis only) of portions of FIGS. 31A and 31B with the left-hand graph in FIG. 32 corresponding to a portion of FIG. 31B and the right-hand graph in FIG. 32 corresponding to a portion of FIG. 31A. From FIG. 32, it is apparent that the settled value of the fast settling inertia simulation is very close to the settled value that exists in the case where the final design value of inertia was used throughout the entire simulation. This confirms the validity of the fast settling model and shows the significant saving of simulation time using the fast settling model.

FIG. 33 is a zoom view (x-axis only) of a portion of the graph of FIG. 31A (the lower graph line in FIG. 33) and a portion of the graph of FIG. 31B (the upper graph line in FIG. 33). This further demonstrates the more rapid settling of the fast settling inertia model.

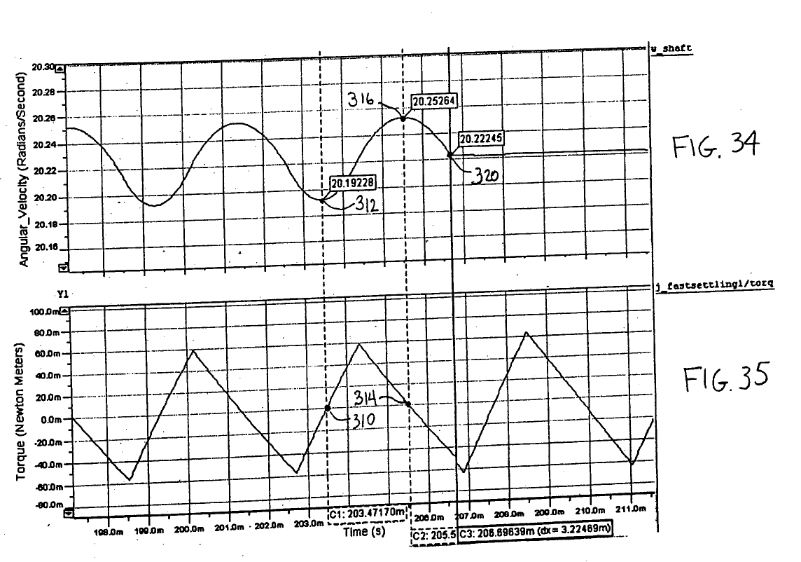

FIGS. 34 and 35 illustrate switching in the fast settling model 300 from an initial inertia value to the design inertia value when the angular velocity (state variable) ripple is between maximum and minimum values, in this case at an average value. That is, in FIG. 35, when the torque applied to the inertia crosses from a negative to a positive value through zero (indicated by point 310), the corresponding angular velocity is at a minimum, shown in FIG. 34 as 20.19228 radians/sec. and indicated by the point 312. In addition, at a falling zero crossing of torque, indicated by point 314 in FIG. 35, the angular velocity is at a maximum, in this case 20.25264 radians/sec., indicated by point 316 in FIG. 34. Thus, angular velocity ripple minimum and maximum values are identified. Switching from the fast settling inertia value to the simulated nominal design inertia value is desirably then accomplished when the angular velocity is between the maximum and minimum values. In FIG. 34 this switching is accomplished at point 320 where the angular velocity is 20.22245 radians/sec. This approach increases the accuracy of the final settled angular velocity in the fast settling model. Switching is also done after a fast settling switching time has elapsed in this model, which in this example was specified as 200 msec.

The model 300 in one specific example is identified by the entity name J_fastSettling defined in VHDL-AMS as follows:

| | |
|---|---|
| entity J_fastSettling is | |
| generic (j_final : mmoment_i; | -- Nominal moment of inertia |
| | -- (Kg*meter**2) |
| j_initial : mmoment_i; | -- Initial moment of inertia |
| | -- (Kg*meter**2) |
| switch_time : time); | -- Switching time from j_initial |
| | -- to j_final [sec] |
| port (terminal rotv1 | |
| : rotational_v); | |
| end entity J_fastSettling; | |

The architecture of this model allows a smaller value of j_initial (the initial inertia) to be used because the specific model identifies the average angular velocity under a periodic, steady-state torque conditions and transitions to a j_final simulation value (corresponding to the design inertia value in the actual circuit), at the moment when the angular velocity is at an average. This transition desirably occurs when the angular velocity is at the average so as to be closer to the actual dynamic steady-state for the system under test.

A specific architecture of an exemplary J_fastSettling model in VHDL-AMS is set forth as follows:

| | |
|---|---|
| architecture torqueAveraging of | |
| J_fastSettling is | |
| quantity w across torq through rotv1 | |
| to rotational_v_ref; | |
| signal j_signal : mmoment_i := | |
| j_initial; | |
| begin | |
| switch : process is | |
| variable angv1, angv2 : real; | -- Angular velocity variables |
| Begin | |
| j_signal <= j_initial; | |
| wait for switch_time; | |
| wait until torq'above(0.0); | -- First torque zero crossing |
| | -- (rising) |
| angv1 :=w; | -- Lowest angular velocity |
| wait until not | |
| torq'above(0.0); | -- Second torque zero crossing |
| | -- (falling) |
| angv2 := w; | -- Highest angular velocity |
| wait until not | -- Angular velocity crossing |
| w'above((angv2 + angv1)/2.0); | -- through average level |
| wait for 1 ps; | -- This helps convergence |
| j_signal <= j_final; | |
| wait; | -- Forever |
| end process switch; | |
| break on j_signal; | |
| torq == j_signal * w'dot; | |
| end architecture torqueAveraging; | |

In the above model, rotv1 is a form of first simulated terminal (e.g. representing the connection point of an inertia element to a mechanical rotational system) and rotational_v_ref is a form of simulated second terminal representing an inertial reference. In addition, in this case the angular velocity w is an across variable and torq is a through variable relative to these terminals.

In this non-periodic or quasi-periodic example, the fast settling technology is still applicable. In the above example, selecting the initial inertia value for the fast settling model depends on the particular application. One can examine the impact of a selected inertia value on driving current by, for example, examining the angular velocity or state variable ripple. Assume in one example that a motor is being driven at 2000 rpm. In this example, one could limit the ripple to be a fraction (e.g., ten percent [200 rpm]) of the motor speed to limit the effects of motor speed changes on output drive current. In a fan system, a generally constant torque on the fan will cause the fan to run at a steady-state angular velocity (wind loading being a major factor) independent of the inertia of the shaft. However, the inertia affects how fast the fan ramps up to its steady-state operating speed. As the speed of operation of the fan changes, this affects the drive current. If the initial inertia value that is selected in the fast settling model is too small, the speed ripple can affect the drive current resulting in the speed not settling to a simulation steady-state that corresponds to the steady-state that is reached if the design simulated value of the inertia were used throughout the simulation. The above factors may be considered in selecting the initial inertia value.

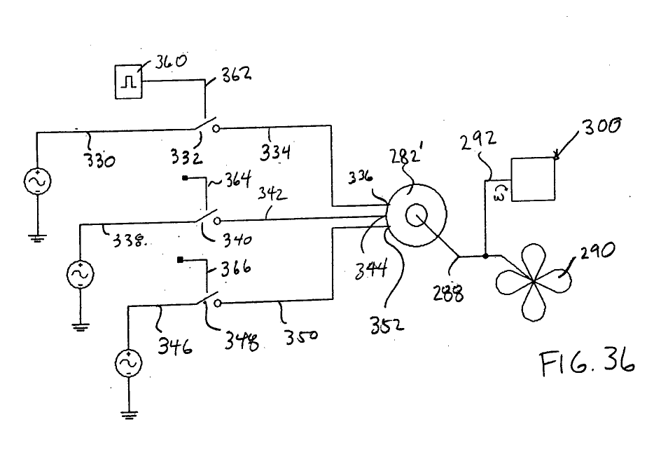

FIG. 36 illustrates another simulation application using the fast settling inertia model 300. Components in the simulation of FIG. 36 that correspond to those in FIG. 30 have been given the same numbers (in some cases with a prime “′” designation). In FIG. 36, an induction motor 282′ is used. In the example of FIG. 36, 3-phase, 60 hertz, 220 volt line voltage is delivered through respective switches 332,340,348 to the induction motor. The first phase is delivered via line 330 (va_line) and a switch 332 (sw9) and a line 334 (va) to terminal 336 (a5) of the 3-phase induction motor 282′ when switch 332 is closed. The switches 332,340 and 348 may have the same characteristics, namely: resistance r_open 10.0 e3; r_closed 10.0 e-3; and real trans_time=10.0 e-6. The second phase is delivered via a line 338 (vb_line) and a switch 340 (sw10). The output of switch 340 when closed is connected by a line 342 (vb) to a terminal 344 (b5) to the induction motor 282′. The third phase of the line voltage is delivered via a line 346 (vc_line), a switch 348 (sw11), a line 350 (vc) and to a third terminal 352 (c5) of motor 282′. The respective switches 332,340 and 348 are digitally controlled by the same digital pulse source 360 in FIG. 36. Source 360 is coupled by a lines 362,364 and 366 (d_start) to the switches 332,340,348. In the illustrated simulation, pulse source 360 may have the following characteristics: dig_pulse; delay_length, initial_delay=1 microsecond; delay_length period=200 seconds. The initial fast settling inertia in the model 300 used in FIG. 36 simulation is set at 0.01 Kg m². The final value of the inertia, j_final, in this example, is 0.1 Kg m². In addition, the switching time is 1.2 seconds. The shaft in this simulation is shown coupled to, in this case connected directly to, a fan 290. The fan in this example has characteristics: real d1=0.0001 (N*M)/(rad/sec); real d2=80.0 e-6 (N*M)/(rad/sec) and moment_1 j=0.0.

In the simulation of FIG. 36, if no fast settling technology is used, the line voltage is applied through switches and the motor slowly drives the heavy inertia (0.1 Kg-m²) up to full speed. The torque produced by an induction motor is cyclic at the slip frequency, which is the difference between the line voltage and the motor shaft speed. So again, in this example, the torque signal applied to the inertia is cyclic but non-synchronous. However, the fast settling inertia model is still able to reduce the simulation time needed to reach the accurate steady-state shaft speed.

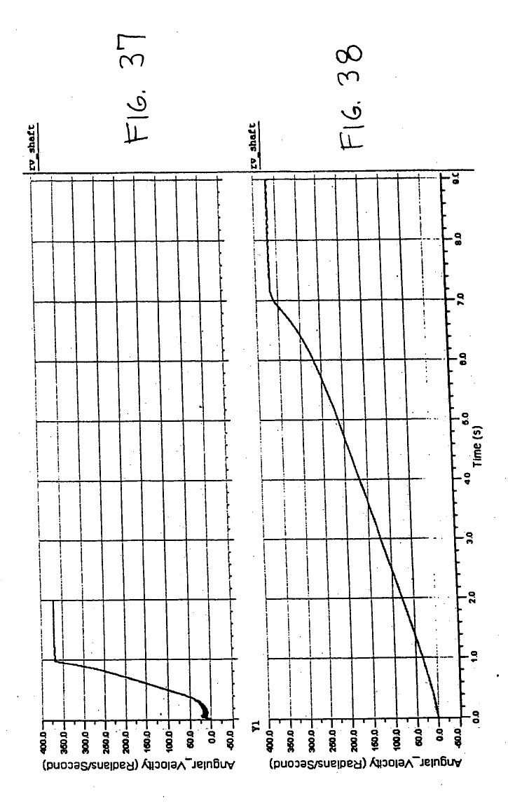

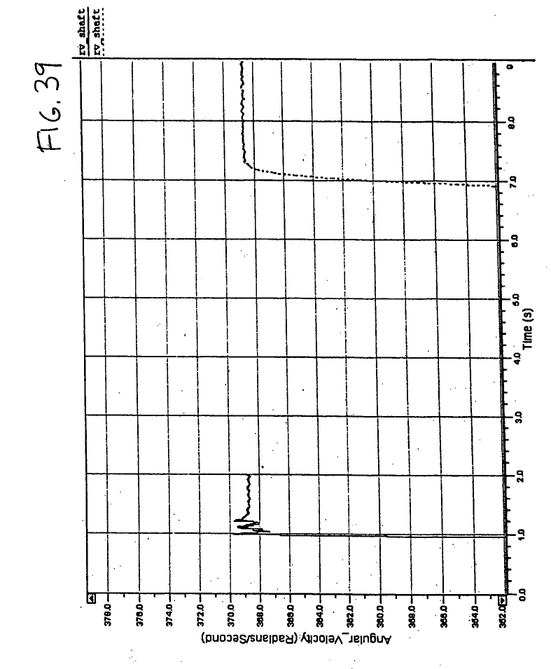

FIG. 38 illustrates the shaft angular velocity (radians/second) for a simulation in which the nominal or design value of inertia (0.1 Kg-m²) is used throughout the simulation. A relatively long simulation time is taken to reach the steady-state. FIG. 37 illustrates the simulation in which the inertia is changed from an initial inertia value of 0.01 Kg-m² to the simulation design value of 0.1 Kg-m² following a first simulation time interval. As one can see from comparing FIGS. 37 and 38, the steady-state is reached much faster utilizing the fast inertia simulation model.

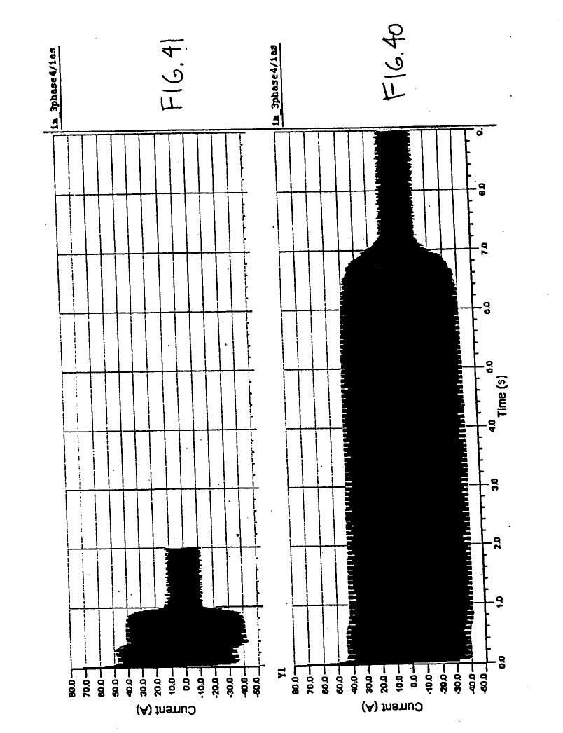

FIG. 39 illustrates a zoomed view (y-axis only) of portions of FIGS. 37 and 38. The left-hand graph in FIG. 39 illustrates a portion of the data from the graph of FIG. 37. The right-hand graph of FIG. 39 illustrates a portion of the data from FIG. 38. Again, this demonstrates the much faster settling that takes place using the fast settling model.

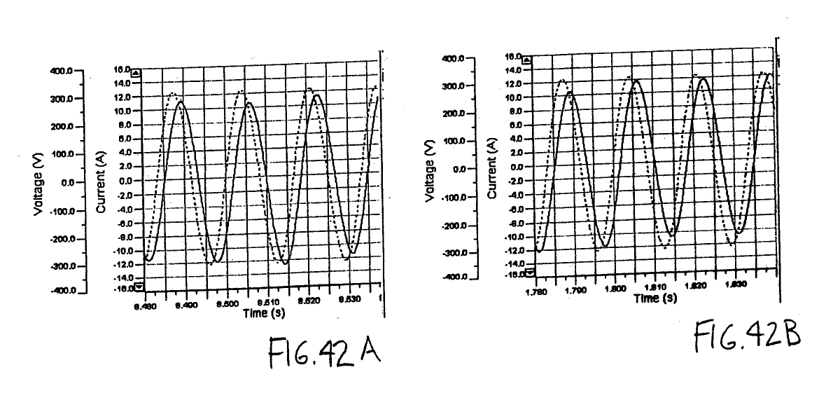

After an induction motor reaches its operating speed, just below synchronous speed, the individual phase currents drop to a much lower level than they are at during the start-up time. FIGS. 40 and 41 illustrate the phase A current settling to its steady-state level. FIG. 41 shows settling in the case where a fast settling inertia model is used where the inertia is shifted from a low initial value to a high design value at time 1.2 sec. In contrast, FIG. 40 illustrates the settling of the phase A to a steady-state level in an example where the simulated design value of the inertia was used throughout the simulation.

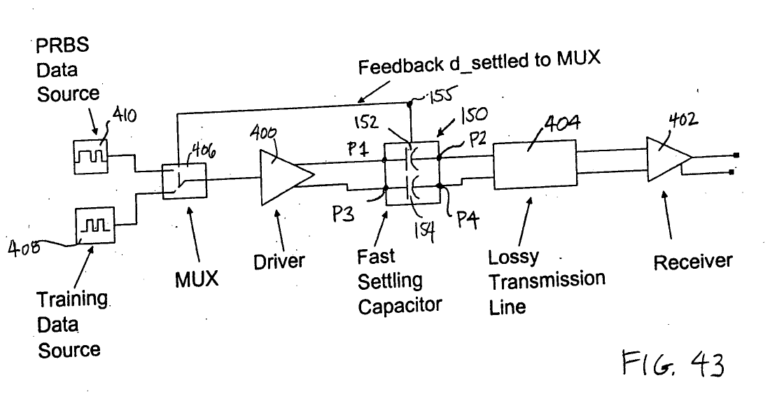

Often a designer only wants to know the power factor of the motor at operating (steady-state) conditions. The power factor is a relative phase of the motor currents with respect to the line voltages. The power factor has an important affect on the electrical supply efficiency and may even affect the rates that a utility charges to an industrial customer. FIG. 42A illustrates the phase A current (solid line) and voltage (dashed line) for a simulation using the final design value of inertia throughout the simulation with FIG. 42A illustrating these conditions after nearly nine seconds of simulation time. FIG. 42B illustrates the same signals in the case where a fast settling inertia model is used, but in under two seconds of simulation time. In the example used to generate the data depicted in FIG. 42B, the switching from the initial inertia value to the nominal or design inertia value occurred at 1.2 seconds of simulation time. In comparing FIG. 42A and 42B, one can see that a very good power factor match is observed, which again verifies the appropriateness of the fast settling model.

As another example, in the case of a fluidic model, for example of a hydraulic accumulator, a model like the J_fastSettling model may be used. In this case the first terminal may represent the port to the accumulator and the second terminal may represent a fluidic zero pressure reference. In addition, in this case, the simulated pressure is an across variable and is also the state variable. The fluid flow would be a through variable in this case.

Desirably, the above technology is implemented via one or more computers which typically include a CPU, memory, a display and an input device such as a mouse and/or a keyboard. Such computers are programmed to implement one or more of the various embodiments disclosed herein. In addition, computer readable media, such as computer discs or cards, may be programmed with computer instructions to carry out the above teachings and may be programmed to contain fast settling models which can be selected as desired for use in simulating a circuit that is being evaluated.

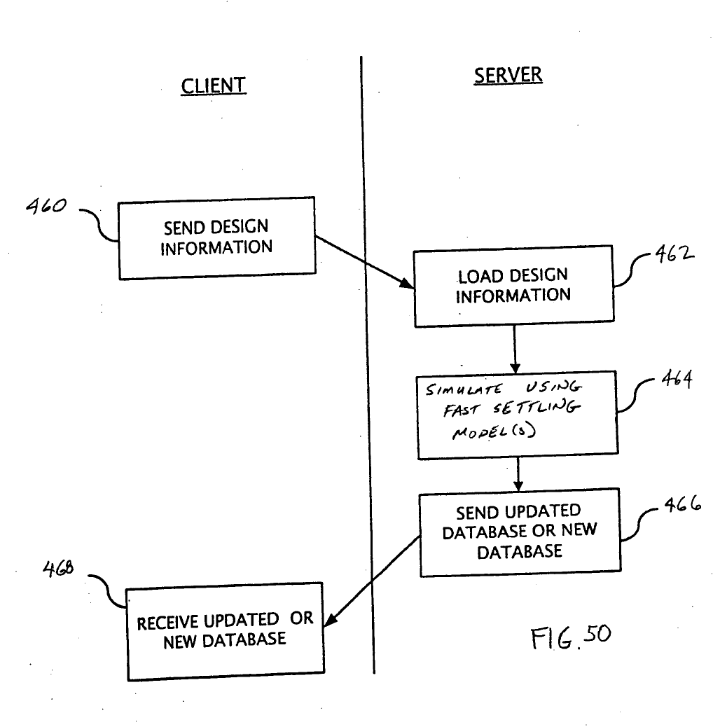

Also, any of the aspects of the technology described above may be performed or designed using a distributed computer network. FIG. 49 shows one such exemplary network. A server computer 440 can have an associated storage device 442 (internal or external to the server computer). For example, the server computer 440 can be configured to perform a simulation using one or more fast settling models and/or techniques disclosed herein (e.g., as part of an EDA software tool). The server computer 440 may be coupled to a network, shown generally at 444, which can comprise, for example, a wide-area network, a local-area network, a client-server network, the Internet, or other such network. One or more client computers, such as those shown at 446, 448, may be coupled to the network 444 using a network protocol.

FIG. 50 shows that a database containing design information (e.g., describing a circuit which is to be simulated). The database may be updated to include design information for circuit designs following simulation using fast settling techniques according to any of the embodiments disclosed herein using a remote server computer, such as the server computer 440 shown in FIG. 49. In process block 460, for example, the client computer sends design data relating to a circuit design which is to be simulated using one or more of the disclosed fast settling models or techniques disclosed herein. For instance, the client computer may send programming instructions for a design with or without a netlist or other EDA design database. In process block 462, the data is received and loaded by the server computer. In process block 464, the received database is simulated using one or more fast settling models or techniques described herein. The simulated circuit may be modified with additional simulations performed. This new design data can be stored as an updated version of the design database or as one or more separate databases. Alternatively, the simulation results may be generated and stored. In process block 466, the server computer sends an updated program for a new circuit design developed as a result of the simulation, and/or an updated database or other databases (e.g., simulation results) to the client computer, which receives the database in process block 468. It should be apparent to those skilled in the art that the example shown in FIG. 50 is not the only way to update a design database to include the relevant design data. For instance, the design data may be stored in a computer-readable media that is not on a network and that is sent separately to the server. Alternatively, the server computer may perform only a portion of the design procedures.

In one exemplary approach, fast settling modeling of any new circuit or system configuration may be verified by running one long simulation with values of energy storage elements at the nominal design values. The results of any fast settling modeling may be compared to the results of the nominal simulation approach to confirm that the fast settling model in fact predicts the steady-state conditions. Repeated simulations during design-tuning optimization and other design-space explorations can then be performed using the verified fast settling model with confidence.

Having illustrated and described the principles of the invention by several embodiments, it should be apparent that those embodiments can be modified in arrangement and detail without departing from such inventive principles. The described embodiments are illustrative only and should not be construed as limiting the scope of the present invention. The present invention is directed to all novel and non-obvious developments set forth herein both alone and in combinations and subcombinations with one another.

1. A method of reducing settling time in a dynamic simulation of a circuit, the circuit comprising at least one circuit capacitor having a circuit capacitance design value, wherein the circuit is designed such that the circuit capacitor receives a signal that switches values, the simulation comprising a simulated capacitor that corresponds to the at least one circuit capacitor, the simulated capacitor having a state variable corresponding to the simulated voltage across the simulated capacitor, the method comprising:
assigning at least one fast settling capacitance value to the simulated capacitor, the at least one fast settling capacitance value corresponding to a capacitance value that is less than the circuit capacitance design value;
performing a first simulation of the circuit with the simulated capacitor assigned at least one fast settling capacitance value;
changing the capacitance value of the simulation capacitor from at least one fast settling capacitance value to a simulated capacitance design value after a first simulation time interval, the simulated capacitance design value corresponding to a capacitance value that simulates the circuit capacitance design value; and
performing a second simulation of the circuit for at least a second simulation time interval after the first simulation time interval with the capacitance value of the simulated capacitor at the simulated capacitance design value and with the second simulation starting with the state variable of the simulated capacitor at the value of the state variable at the end of the first simulation.

2. A method according to claim 1 wherein the second simulation time interval immediately follows the first simulation time interval.

3. A method according to claim 1 wherein there is a delay between the first and second simulations.

4. A method according to claim 1 comprising the act of using a training sequence signal as a training input for the simulated circuit for at least a portion of the first simulation.

5. A method according to claim 4 wherein the training sequence signal is periodic, and wherein the act of changing the capacitance value of the simulation capacitor comprises determining whether the simulation time has reached a capacitance value switch time, continuing the training sequence for a continued training time interval following the reaching of the capacitance value switch time and changing the capacitance value of the simulated capacitor to the simulated capacitance design value after the continued training time interval.

6. A method according to claim 5 wherein the continued training time interval is more than one “0”, “1″” two bit cycle of a repeating “0″” to “1″” to “0″” to “1″” training sequence signal.

7. A method according to claim 5 wherein the training sequence comprises a repetitive pattern of logic level 1 and logic level 0 data bits.

8. A method according to claim 1 wherein the duration of the first simulation time interval is predetermined by a user.

9. A method according to claim 1 wherein the duration of the first simulation time interval is at least equal to the simulation time interval required for the state variable of the simulated capacitor to settle to an equilibrium or steady-state condition.

10. A method of reducing settling time in a dynamic simulation of a circuit, the circuit comprising at least one circuit capacitor having a circuit capacitance design value, wherein the circuit is designed such that the circuit capacitor receives a signal that switches values, the simulation comprising a simulated capacitor that corresponds to the at least one circuit capacitor, the method comprising:
assigning at least one fast settling capacitance value to the simulated capacitor, the at least one fast settling capacitance value corresponding to a capacitance value that is less than the circuit capacitance design value;
performing a first simulation of the circuit with the simulated capacitor assigned at least one fast settling capacitance value;
changing the capacitance value of the simulation capacitor from at least one fast settling capacitance value to a simulated capacitance design value after a first simulation time interval, the simulated capacitance design value corresponding to a capacitance value that simulates the circuit capacitance design value;
performing a second simulation of the circuit for at least a second simulation time interval after the first simulation time interval with the capacitance value of the simulated capacitor at the simulated capacitance design value; and
wherein plural second simulations are performed utilizing results from the first simulation as the starting condition for the second simulations.

11. A method of reducing settling time in a dynamic simulation of a circuit, the circuit comprising at least one circuit capacitor having a circuit capacitance design value, wherein the circuit is designed such that the circuit capacitor receives a signal that switches values during operation of the circuit, the simulation comprising a simulated capacitor that corresponds to the at least one circuit capacitor, the method comprising:
assigning at least one fast settling capacitance value to the simulated capacitor, the at least one fast settling capacitance value corresponding to a capacitance value that is less than the circuit capacitance design value;
performing a first simulation of the circuit with the simulated capacitor assigned at least one fast settling capacitance value;
changing the capacitance value of the simulated capacitor from at least one fast settling capacitance value to a simulated capacitance design value after a first simulation time interval, the simulated capacitance design value corresponding to a capacitance value that simulates the circuit capacitance design value;
performing a second simulation of the circuit for at least a second simulation time interval after the first simulation time interval with the capacitance value of the simulated capacitor at the simulated capacitance design value; and
wherein the capacitance value of the simulated capacitor is changed to the simulated capacitance design value following settling of the simulated capacitor during the first simulation to an equilibrium or steady-state condition.

12. A method according to claim 11 wherein the method comprises producing a settled indicating signal that indicates settling of the simulated capacitor to the equilibrium or steady-state condition.

13. A method according to claim 11 wherein the capacitance value of the simulated capacitor is changed to the simulated capacitance design value following settling of the across voltage of the simulated capacitor to an equilibrium or steady-state condition and under simulation conditions corresponding to the across voltage of the simulated capacitor being at a first value that is between high and low across voltage values.

14. A method according to claim 13 wherein the first value is an average of the simulated capacitor high and low across voltage values.

15. A method according to claim 13 wherein the capacitance value of the simulated capacitor is changed to the simulated capacitance design value when either or both the difference in the maximum across voltages of succeeding cycles of the output of the simulated capacitor and the difference in the minimum across voltages of the simulated capacitor are no greater than a voltage difference threshold.

16. A method according to claim 15 wherein the succeeding cycles immediately follow one another.

17. A method according to claim 11 wherein plural different fast settling capacitance values are used in performing the first simulation.

18. A method according to claim 11 wherein the user designates at least one fast settling capacitance value.

19. A method according to claim 11 wherein the act of assigning at least one fast setting capacitance value comprises the act of evaluating the ripple of the across voltage of the simulated capacitor in response to applied signals and adjusting the fast settling capacitance value based upon an evaluation of the ripple.

20. A method according to claim 19 in which the act of adjusting the fast settling capacitance value comprises increasing the fast settling value in the event the ripple exceeds a first threshold and decreasing the fast settling value in the event the ripple is below a second threshold, and wherein the second threshold is less than the first threshold.

21. A method according to claim 20 in which an existing fast settling capacitance value is adjusted to a new fast settling capacitance value by multiplying the existing fast settling capacitance value by a first factor in the event the ripple exceeds the first threshold and by dividing the existing fast settling capacitance value by a second factor in the event the ripple is a third factor less than the first threshold.

22. A method according to claim 21 wherein an initial fast settling capacitance value is at least 1000 times the simulated capacitance design value, the first factor is three, the second factor is three and the third factor is one-fourth.

23. A method according to claim 11 wherein the circuit comprises at least one pair of differential capacitors comprising first and second circuit capacitors, the simulation comprising first and second simulated capacitors respectively corresponding to the respective first and second circuit capacitors, and wherein the act of changing the simulated capacitance values of the first and second simulated capacitors to their respective simulated capacitance design values takes place after a state variable of one of the first and second simulated capacitors is settled to an equilibrium or steady-state condition, only the state variable of said one of the first and second simulated capacitors being used to determine the settling to an equilibrium or steady-state condition.

24. A computer programmed to carry out the method of claim 11.

25. Computer readable media programmed with instructions to carry out the method of claim 11.

26. A computer file storing the results of a simulation carried out in accordance with the method of claim 11.

27. A method of simulating a circuit comprising at least one energy storage element having an energy storage element coefficient design value, the energy storage element having a storage element energy state variable that has a ripple when operating in the circuit in response to an excitation, the energy storage element requiring time for the storage element energy state variable to settle to an equilibrium or steady-state condition following the initial application of the excitation, the method comprising:
performing a first simulation of the circuit with a simulated energy storage element having at least one fast settling simulation coefficient value that is less than a design coefficient simulation value that corresponds to the energy storage element coefficient design value, the simulated energy storage element having a simulated energy state variable that corresponds to the storage element energy state variable; and
changing the at least one fast settling simulation coefficient value to the design coefficient simulation value following settling of the simulated energy state variable to an equilibrium or steady state condition.

28. A method according to claim 27 comprising changing the at least one fast simulation coefficient value to the design simulation coefficient value when the simulated energy state variable is at a value between the maximum and minimum simulation energy state variable values.

29. A method according to claim 27 wherein the energy storage element comprises one or more of any of a capacitor, an inductor, an inertia or other mechanical energy storage element.

30. A method according to claim 27 wherein the energy storage element comprises an AC coupling capacitor in a circuit designed for operation at a frequency in excess of one gigahertz.

31. A computer programmed to carry out the method of claim 27.

32. Computer readable media programmed with instructions to carry out the method of claim 27.

33. A computer file storing the results of a simulation carried out in accordance with the method of claim 27.

34. A method according to claim 27 comprising producing a settled indicating signal that indicates settling of the simulated energy state variable to an equilibrium or steady state condition.

35. A method according to claim 27 wherein the simulated energy storage element coefficient value is changed to the design coefficient simulation value when the simulated energy state variable is at a value between the maximum and minimum energy state variable values.

36. A method according to claim 27 wherein the value of the simulated energy storage element coefficient is changed to the design coefficient simulation value substantially at a midpoint of maximum and minimum simulated energy state variable values.

37. A method of reducing settling time in a dynamic simulation of a circuit, the circuit comprising at least one circuit capacitor having a circuit capacitance design value, wherein the circuit is designed such that the circuit capacitor receives a signal that switches values during operation of the circuit, the simulation comprising a simulated capacitor that corresponds to the at least one circuit capacitor, the simulated capacitor having a state variable corresponding to a voltage across the simulated capacitor, the method comprising:
assigning at least one fast settling capacitance value to the simulated capacitor, the at least one fast settling capacitance value corresponding to a capacitance value that is less than the circuit capacitance design value;
performing a first simulation of the circuit with the simulated capacitor assigned at least one fast settling capacitance value;
changing the capacitance value of the simulation capacitor from at least one fast settling capacitance value to a simulated capacitance design value after a first simulation time interval, the simulated capacitance design value corresponding to a capacitance value that simulates the circuit capacitance design value; and
performing a second simulation of the circuit for at least a second simulation time interval after the first simulation time interval with the capacitance value of the simulated capacitor at the simulated capacitance design value and with the second simulation starting with the state variable of the simulated capacitor at the value of the state variable of the simulated capacitor at the end of the first simulation;
applying a periodic training stimulus signal sequence as a training input for the simulated circuit for at least a portion of the first simulation;
wherein the simulated capacitor value is changed to the simulated capacitance design value following settling of the state variable to an equilibrium or steady-state condition and under simulation conditions corresponding to the state variable being between maximum and minimum state variable values; and
producing a settled indicating signal that indicates settling of the state variable to the equilibrium or steady-state condition.

38. A method according to claim 37 wherein the act of assigning at least one fast settling capacitance value comprises the act of evaluating the ripple of the state variable in response to received stimulus signals and adjusting the fast settling capacitance value assigned to the simulated capacitor based upon an evaluation of the ripple of the state variable, and wherein the act of adjusting the fast settling capacitance value comprises increasing the fast settling capacitance value in the event the ripple of the state variable exceeds a first threshold and decreasing the fast settling value in the event the ripple of the state variable is below a second threshold.

39. A method according to claim 37 wherein the circuit comprises at least one pair of differential capacitors comprising first and second circuit capacitors, the simulation comprising first and second simulated capacitors respectively corresponding to the respective first and second circuit capacitors, and wherein the act of changing the simulated capacitance values of the first and second simulated capacitors to their respective simulated capacitance design values takes place after the state variable of one of the first and second simulated capacitors is settled to an equilibrium or steady-state condition, only the state variable of said one of the first and second simulated capacitors being used to determine the settling to an equilibrium or steady-state condition.

40. A simulated energy storage element model for use in simulating the behavior of an actual energy storage element having an actual energy storage coefficient design value indicative of the energy storage capacity of the actual energy storage element, the actual energy storage element having an actual energy state variable that settles to an equilibrium or steady-state in response to excitation signals, the model comprising:
simulated first and second terminals and a simulated state variable corresponding to the value of a variable across or through the first and second terminals;
a simulated energy storage coefficient indicative of the energy storage capacity of the simulated energy storage element; and
the model permitting the adjustment of the value of the simulated energy storage coefficient from at least one fast settling simulated coefficient value to a simulated design coefficient value, the simulated design coefficient value corresponding to the coefficient value for a simulated energy storage element that simulates the actual energy storage element having the actual energy storage element coefficient design value, wherein the fast settling simulated coefficient value is less than the simulated design coefficient value, and wherein; adjustment of the value of the simulated energy storage coefficient is made from a fast settling coefficient value to the simulated design coefficient value following the settling of the simulated state variable to a steady-state or equilibrium condition.

41. A model according to claim 40 wherein the value of the simulated energy storage coefficient is adjusted to the simulated design coefficient value after a user designated simulation time period.

42. A model according to claim 40 wherein the value of the simulated energy storage coefficient is adjusted to the simulated design coefficient value by the model at a simulation time determined by the model.

43. A model according to claim 40 in which the fast settling simulated coefficient value is adjusted to plural fast settling simulated coefficient values prior to adjusting the simulated fast settling coefficient value to the simulated design coefficient value.

44. A model according to claim 40 wherein the model adjusts the simulated energy storage coefficient value to the simulated design coefficient value following the settling of the simulated state variable to an equilibrium or steady-state condition.

45. A model according to claim 40 which monitors the simulated state variable and changes the simulated energy storage coefficient value to the simulated design coefficient value when the simulated state variable is between maximum and minimum values.

46. A model according to claim 45 wherein the simulated state variable is at an average of the maximum and minimum values when the simulated energy storage coefficient value is changed to the simulated design coefficient value.

47. A model according to claim 40 which produces a signal indicating the settling of the simulated state variable to the equilibrium or steady-state condition.

48. A model according to claim 40 wherein the actual energy storage element is a capacitor, the simulated energy storage coefficient value is the simulated capacitance value of a simulated capacitor that simulates the actual energy storage element, and the simulated state variable corresponds to the simulated voltage across the simulated capacitor.

49. A model according to claim 48 which changes the simulated capacitance value of the simulated capacitor to the simulated design capacitance value corresponding to the actual energy storage element coefficient design value when either or both the maximum voltages of successive cycles of simulated state variables and the minimum voltages of successive cycles of simulated state variables are no greater than a voltage difference threshold.

50. A model according to claim 48 which evaluates the ripple of the state variable of the simulated capacitor and changes the simulated capacitance value of the simulated capacitor based upon an evaluation of the ripple.

51. A model according to claim 50 that increases the simulated capacitance value from one fast settling simulated capacitance value to another fast settling simulated capacitance value in the event the ripple of the state variable exceeds a first threshold and decreases the simulated capacitance value from one fast settling simulated capacitance value to another fast settling simulated capacitance value in the event the ripple of the state variable is below a second threshold.

52. A model according to claim 40 wherein the model is of energy storage elements comprising at least one pair of differential capacitors comprising simulated first and second circuit capacitors, the model changing the simulated capacitance value of both of the simulated first and second circuit capacitors to their respective simulated capacitance design values after the state variable from one of the first and second simulated capacitors is settled to an equilibrium or steady-state condition.

53. Computer readable media programmed with instructions to carry out the model of claim 40.

54. A model according to claim 40 wherein the first terminal represents the connection point of an inertia element to a mechanical rotational system, the second terminal represents an inertial reference, and wherein the simulated state variable corresponds to angular velocity.

55. A model according to claim 40 wherein the first terminal represents a first terminal of an electrical circuit component, the second terminal represents a second terminal of an electrical circuit component, and wherein the simulated state variable corresponds to current or voltage.

56. A model according to claim 40 wherein the first terminal represents the port to a hydraulic accumulator, the second terminal represents a fluidic zero pressure reference for the hydraulic accumulator and the simulated state variable corresponds to pressure within the accumulator.

57. A method of dynamically simulating a circuit having at least one circuit capacitor with a circuit capacitor design value, the method comprising:
initializing the capacitance value of a simulated capacitor in the circuit simulation to a capacitance value that is less than the capacitance value of the simulated capacitor that corresponds to the circuit capacitor design value, the simulated capacitor simulating the performance of the circuit capacitor;
applying a training signal to a simulation of the circuit;
detecting the settling of a state variable of the simulated capacitor to a settled equilibrium or steady-state;
changing the capacitance value of the simulated capacitor to a new capacitance value corresponding to the capacitance value that simulates the circuit capacitor at the circuit capacitor design value; and
changing the training signal to a simulated data signal.

58. A method according to claim 57 in which the method acts are carried out in the order recited in claim 57.
